(19) United States
(12) Patent Application Publication
(10) Pub. No.: US 2008/0205406 A1
(43) Pub. Date: Aug. 28, 2008

(54) RECORDING MEDIUM HAVING RECEPTION PROGRAM RECORDED THEREIN, RECORDING MEDIUM HAVING TRANSMISSION PROGRAM RECORDED THEREIN, TRANSMISSION/RECEPTION SYSTEM AND TRANSMISSION/RECEPTION METHOD

(75) Inventor: Kuniyuki Hatakeyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/037,389

(22) Filed: Feb. 26, 2008

(30) Foreign Application Priority Data
Feb. 27, 2007 (JP) 2007-48143

(51) Int. Cl. H04L 12/28

(52) U.S. Cl. 370/394

(57) ABSTRACT

The reception program making a transmission-destination computer control the processing of receiving a packet having the same content which is transmitted from a transmission-source computer through plural routes.

The reception program making the transmission-destination computer compare the transmission order information of the packets.

If the packet is duplication, the reception program making the transmission-destination computer neglect the duplicate packet.

If the packet is lack, the reception program making the transmission-destination computer requests to resend the lack packet to the transmission-source computer.

### TECHNICAL FIELD

The present invention relates to a technique of enhancing reliability of data transmission based on a protocol which does not assure arrival of data by multiplexing a transmission route.

### BACKGROUND

Data transmission through networks have been hitherto carried out in various fields. The data transmission is carried out according to various protocols, and particularly TCP (Transmission Control Protocol) and UDP (User Datagram Protocol) are protocols which have been widely used. Each of TCP and UDP is a protocol of a transport layer (which is also called as Layer 4) of an OSI (Open Systems Interconnection) reference model, and it has been widely used in combination with IP (Internet Protocol) which is a protocol of a network layer (which is also called Layer 3).

TCP and UDP have the following differences, and thus a more proper protocol is selected from TCP and UDP and used in accordance with the property of an application field.

(1) TCP is a protocol which assures that data reaches a transmission destination, and UDP is a protocol which does not assure that data reaches a transmission destination.

(2) When an error occurs in transmission, in the data transmission based on TCP, a packet is automatically re-transmitted. However, in the data transmission based on UDP, a packet is merely discarded.

(3) TCP is a connection type protocol for establishing connection before actual communication is started, however, UDP is a connectionless type protocol.

(4) As described above, TCP requires various other processing than data transmission itself, however, UDP does not execute such processing. Accordingly, the data transmission based on UDP is executed at higher speed than the data transmission based on TCP, and has a higher throughput. In other words, the data transmission based on TCP has high reliability because it has arrival acknowledge and re-transmission control, however, the data transmission based on UDP has low reliability.

Which one of TCP and UDP should be used as the protocol is determined in consideration of various kinds of factors such as the amount of data, the purpose of transmitting data, the type of data, etc. In general, TCP is frequently used for applications in which importance is given to the reliability, and UDP is frequently used for applications in which importance is given to the processing speed. However, there is a situation that both high throughput and high reliability are required.

For example, in a fault tolerant system, there is a case where two computers are paired and one of the computers is used as an active (working) device while the other computer is used as a standby (waiting) device. By adopting such a construction, even when trouble occurs in the active device, services can be continued to be supplied to the external by switching the working function to the standby device. Such a construction enhances the availability of the services.

In order to switch the working function to the standby device, the standby device must take over data held in the active device and the data concerned are transferred. When the active device and the standby device are connected to each other through a network, the succession of the data accompanies the data transmission through the network.

From the viewpoint of availability of services, it is clearly preferable that the time required for the switching operation between the active device and the standby device be shorter. Accordingly, the data transmission speed for data synchronisation is desired to be high. On the other hand, in the system as multiplexed as described above, it is important that the data held in the present active device be reliably taken over by the present standby device.

In the example as described above, both the high throughput which is an advantage of UDP and the high reliability which is an advantage of TCP are required to be compatible with each other.

In the case of use of a communication protocol which does not assure the arrival of data as in the case of UDP, the following first and second methods are generally provided as a method of enhancing the reliability.

According to the first method, both a reception side and a transmission side are controlled on the basis of software of an upper layer for calling a communication protocol such as UDP or the like so that the reception side returns an arrival acknowledge packet when receiving a data packet, and the transmission side re-transmits the data packet when receiving no arrival acknowledge packet. Accordingly, even when the arrival acknowledge and the re-transmission control are not incorporated into the communication protocol itself, the arrival acknowledge and the re-transmission are implemented, and the reliability is enhanced.

However, this method has a disadvantage that some degree of standby time is taken until data are re-transmitted when an error occurs in the data transmission. That is, occurrence of an error is directly linked to reduction of the throughput. Communication programs which do not assure the arrival of data are frequently used when a high throughput is required, but reduction of the throughput is not desired.

The second method is a method of multiplexing the transmission path. If the probability that troubles will occur in all the transmission paths at the same time is low enough, data can actually surely arrive at a transmission destination through at least one transmission path by transmitting the same data through a plurality of different transmission paths. However, the problem with this method is that data are duplicatively transmitted from plural transmission paths when viewed from the data transmission destination, that is, the reception side.

However, as described above, the first method has the disadvantage that some degree of time is taken until the re-transmission of the data. Furthermore, in the second method, the advantage that the transmission path is multiplexed is not sufficiently helpful.

For example, even when trouble actually occurs in the first transmission path while the second transmission path is normal, it is sometimes misjudged that both the first and second transmission paths are normal. As a result, the first transmission path may be selected as a transmission path along which data should be received. Such a situation may occur if a problem occurs in a circuit for detecting abnormality of the transmission path or an actual problem occurs just after the transmission path is judged as being normal, and thus data are transmitted through the wrong transmission path.

In this example, the device as the reception side does not select the second transmission path as a transmission path through which data should be received although the data are actually normally transmitted from the second transmission path, and thus the normal data cannot be received. That is, the normal data transmitted through the second transmission path is erroneously discarded, so that the rate of transmitting the data to the transmission destination correctly is reduced.

### SUMMARY

A computer-readable storage medium has a reception program recorded therein. The reception program makes a transmission-destination computer control the process of receiving a packet having the same content which is transmitted from a transmission-source computer through plural routes according to a protocol which does not assure arrival of data while transmission order information indicating a transmission order of different packets is contained in the packet concerned. The program also recognizes duplication and extinction of a packet. The processing includes:

a reception step of receiving the packet transmitted through any of the plural routes;

a transmission order information obtaining step of obtaining the transmission order information from the received packet;

a reception order information obtaining step of obtaining from a storage unit reception order information which is managed on the basis of the transmission order information of packets previously received behind and represents the order corresponding to a packet which is expected to be received next;

a comparison step of comparing a first order represented by the transmission order information and a second order representing the reception order information;

a duplication judging step of judging that the packet received in the reception step is duplicative with other packets received previously when the first order is prior to the second order;

a normal processing step of up-dating the storage unit so that the order represented by the reception order information stored in the storage unit is the next order when the first order is equal to the second order; and

an extinction judging step of judging that packet extinction occurs when the first order is subsequent to the second order.

### BRIEF DESCRIPTION OF THE DRAWINGS

FIG. 1 is a diagram showing the overall construction of a data transmission system used by the present invention;

FIG. 2 is a diagram showing a duplex system for synchronizing data;

FIG. 3 shows an example of a data transmission control table;

FIG. 4 is a block diagram showing threads constituting middleware for implementing a common memory controller;

FIG. 5 is a diagram showing formats of various kinds of packets;

FIG. 6 is a flowchart showing common memory data transmission processing;

FIG. 7 is a flowchart showing refresh request reception processing;

FIG. 8 is a flowchart showing refresh response reception processing;

FIG. 9 is a flowchart of common memory data reception processing;

FIG. 10 is a processing sequence diagram showing an initial state and a normal processing result subsequent to the initial stat;

FIG. 11 is a processing sequence diagram when a common memory data packet is extinguished;

FIG. 12 is a processing sequence diagram when an active device is re-started;

FIG. 13 is a processing sequence diagram showing overflow of a transmission serial number and a reception serial number; and

FIG. 14 is a block diagram showing a computer executing a program.

### DETAILED DESCRIPTION OF THE EMBODIMENTS

Data transmission through networks have been hitherto carried out in various fields. The data transmission is carried out according to various protocols, and particularly TCP (Transmission Control Protocol) and UDP (User Datagram Protocol) are protocols which have been widely used. Each of TCP and UDP is a protocol of a transport layer (which is also called as Layer 4) of an OSI (Open Systems Interconnection) reference model, and it has been widely used in combination with IP (Internet Protocol) which is a protocol of a network layer (which is also called as Layer 3).

TCP and UDP have the following differences, and thus a preferable protocol is selected from TCP and UDP and used in accordance with the property of an application field.

(1) TCP is a protocol which assures that data reaches a transmission destination, and UDP is a protocol which does not assure that data reaches a transmission destination.

(2) When an error occurs in transmission, in the data transmission based on TCP, a packet is automatically re-transmitted. However, in the data transmission based on UDP, a packet is merely discarded.

(3) TCP is a connection type protocol for establishing connection before actual communication is started, however, UDP is a connectionless type protocol.

(4) As described above, TCP requires various other processing than data transmission itself, however, UDP does not execute such processing. Accordingly, the data transmission based on UDP is executed at higher speed than the data transmission based on TCP, and has a higher throughput. In other words, the data transmission based on TCP has high reliability because it accompanies arrival acknowledge and re-transmission control, but, the data transmission based on UDP has low reliability.

Which one of TCP and UDP should be used as the protocol is determined in consideration of various kinds of factors such as the amount of data, the purpose of transmitting data, the type of data, etc. In general, TCP is frequently used for applications in which importance is given to the reliability, and UDP is frequently used for applications in which importance is given to the processing speed. However, sometimes both high throughput and high reliability are required.

For example, in a fault tolerant system, there is a case where two computers are paired and one of the computers is used as an active (working) device while the other computer is used as a standby (waiting) device. By adopting such a construction, even when trouble occurs in the active device, services can continue to be supplied to the customer or other user by switching the active device functions to the standby device. That is, the construction as described above enhances the availability of the services.

In order to switch the active device to the standby device, the standby device must obtain the data held in the active device and data accuracy should be confirmed. When the active device and the standby device are connected to each other through a network, the succession of the data accompanies the data transmission through the network.

From the viewpoint of availability of services, it is clearly preferable that the time required for the switching operation between the active device and the standby device be shorter. Accordingly, the data transmission speed for data synchronization is desired to be high. On the other hand, in the system as multiplexed as described above, it is important that the data held in the present active device are accurately taken over by the present standby device.

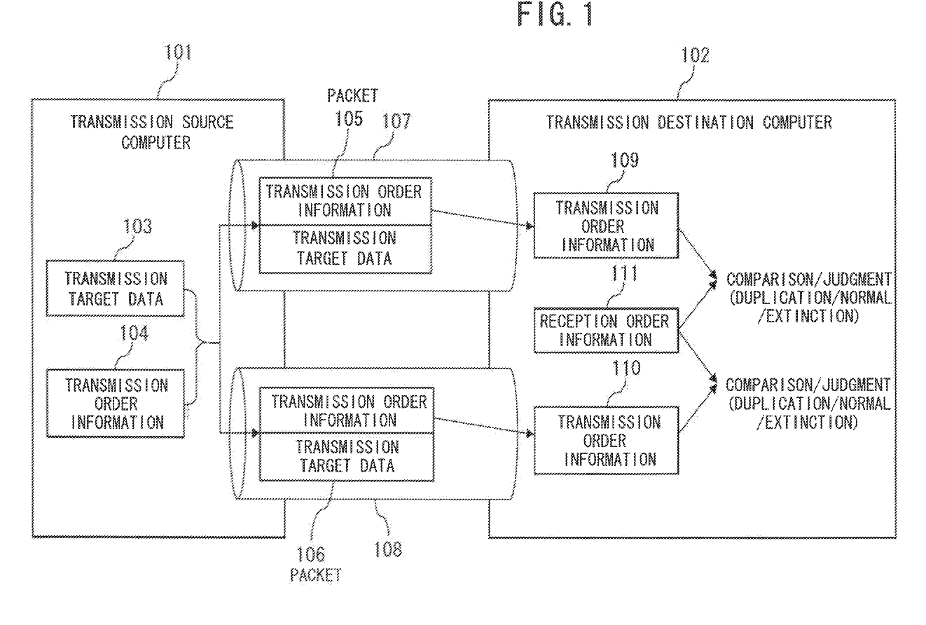

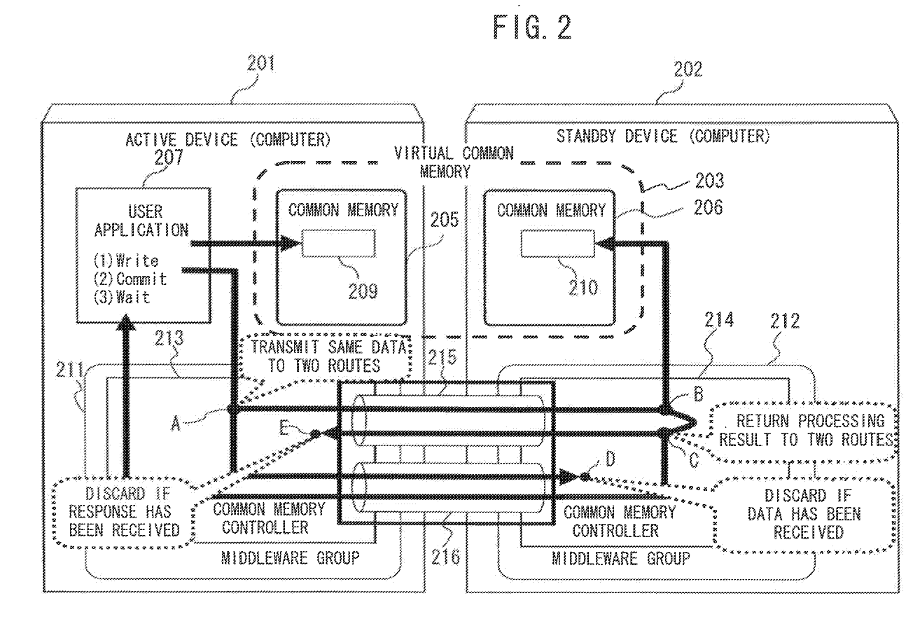

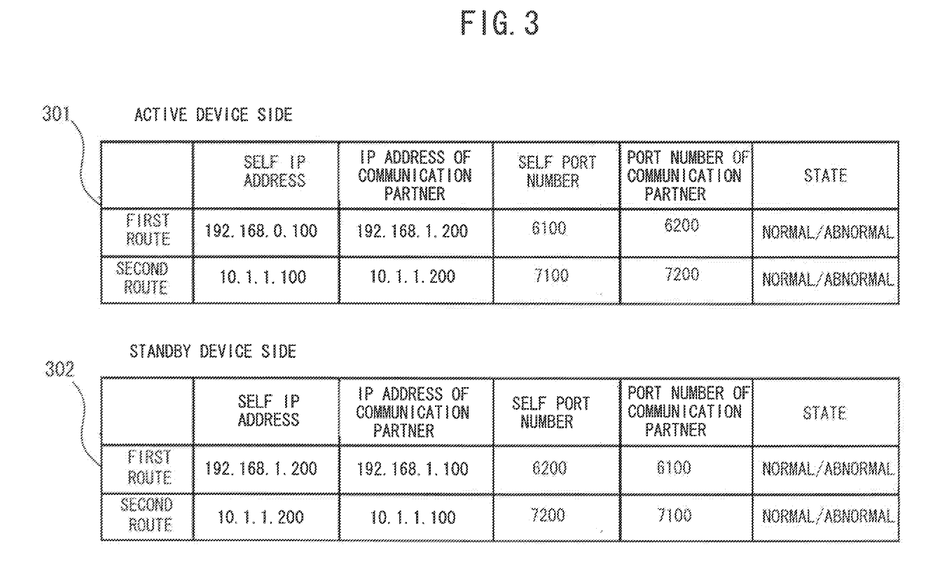

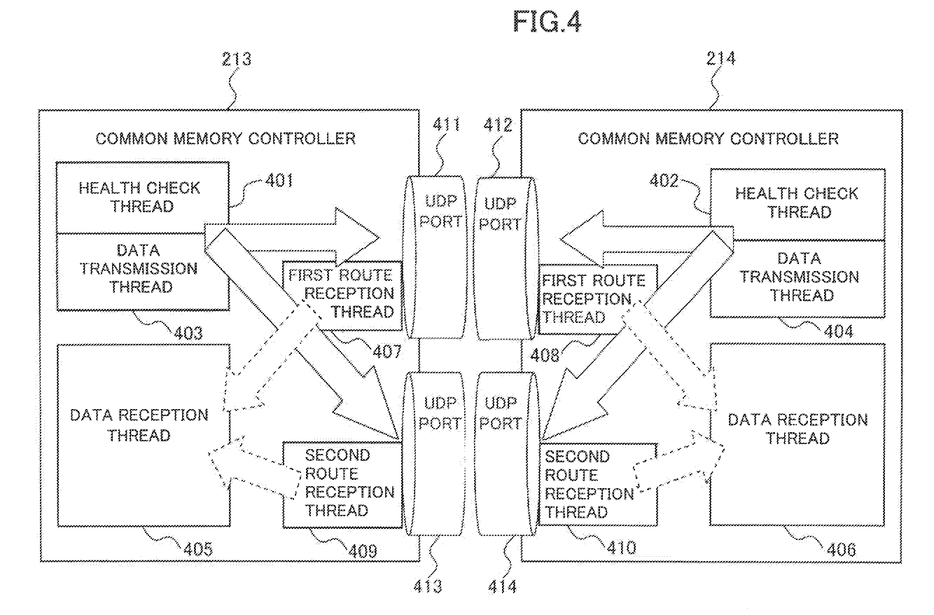

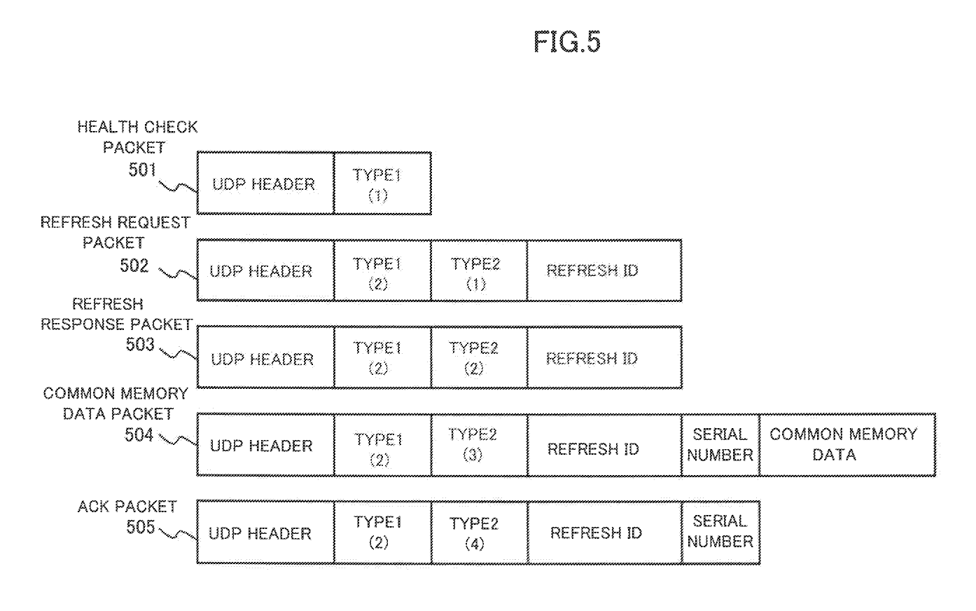

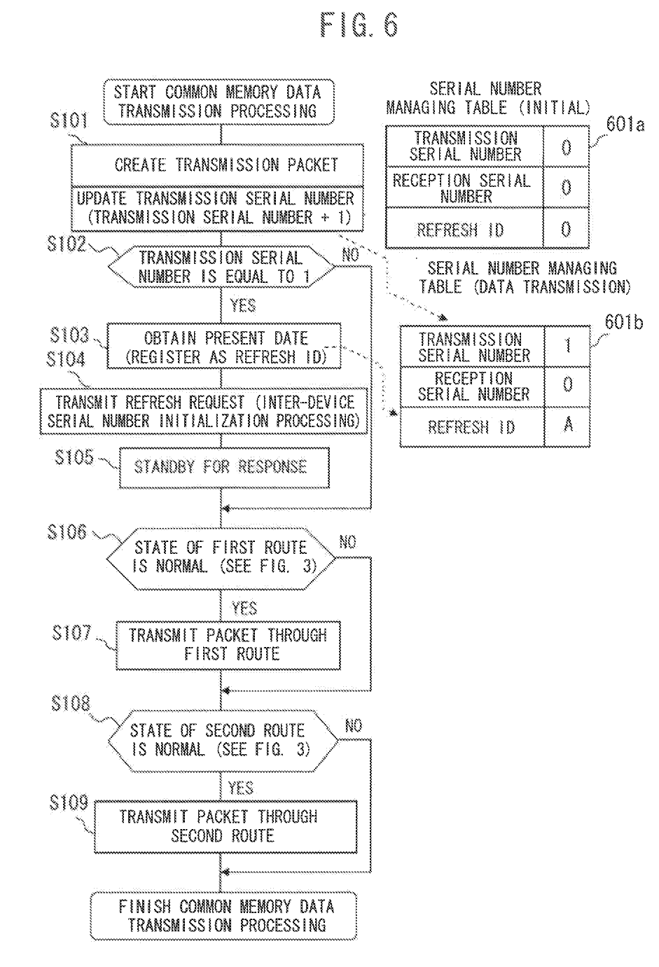

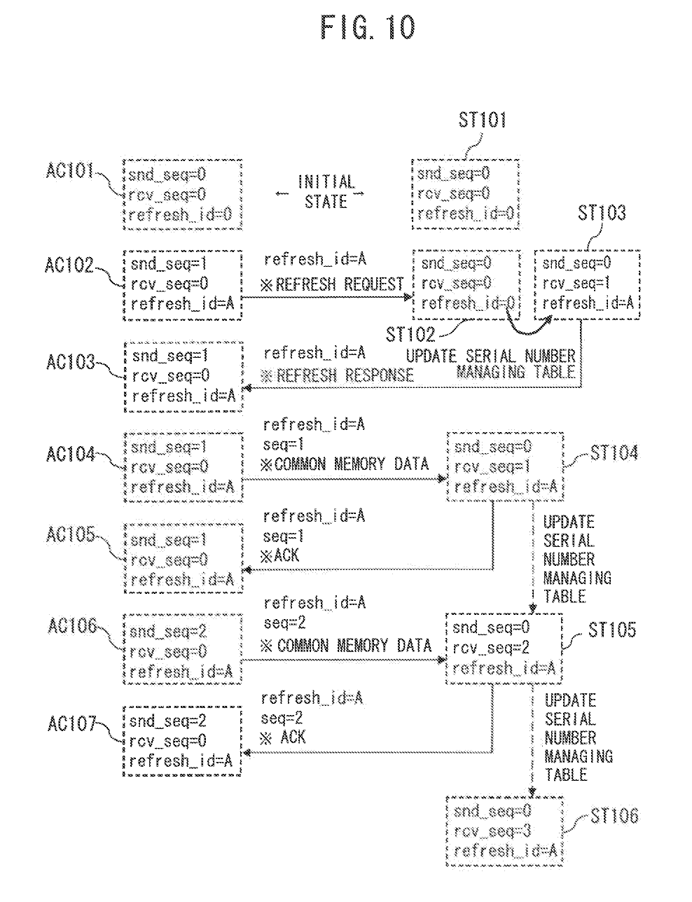

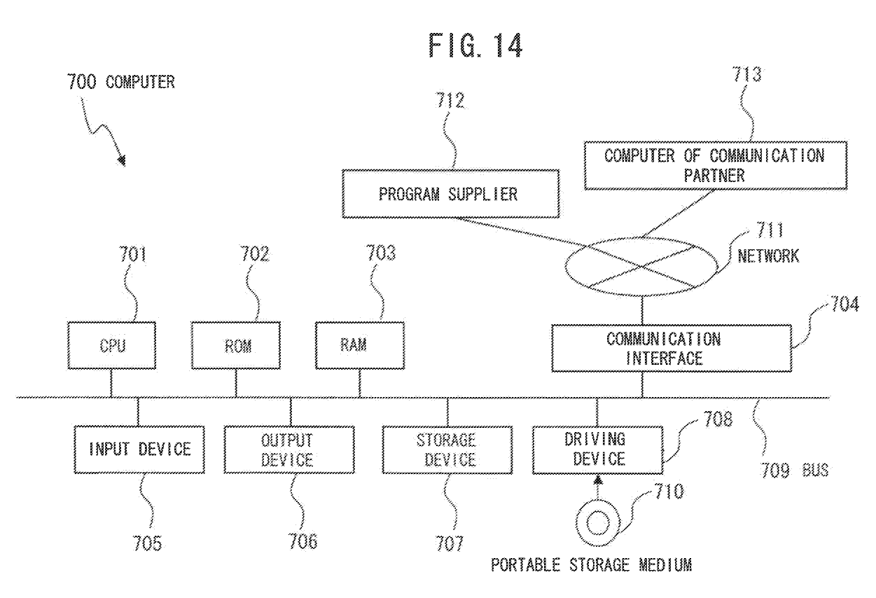

Embodiments of the present invention will be described hereunder in detail with reference to the accompanying drawings, The description will be made in the following order. First, the description will be made with reference to FIG. 1, and then an example of the construction of a system will be described with reference to FIG. 2. Thereafter, a data transmission control table of FIG. 3, the construction of threads of FIG. 4, the construction of packets of FIG. 5, flowcharts of FIGS. 6 to 9 and processing sequence diagrams of FIGS. 10 to 13 will be described by using an embodiment of FIG. 2. Thereafter, a block diagram of a computer executing a program will be described with reference to FIG. 14, and finally various modifications will be described.

FIG. 1 shows flow of transmission target data 103 from a transmission-source computer 101 to a transmission-destination computer 102.

The target data to be transmitted from the transmission-source computer 101 to the transmission-destination computer 102 are the transmission target data 103. The transmission-source computer 101 and the transmission-destination computer 102 are connected to each other through plural communication routes (hereinafter merely referred to as “route”). Each route is a wired route, a wireless route or a route based on the combination thereof. In FIG. 1, two routes 107 and 108 are shown. The communications through the routes 107 and 108 are carried out according to a protocol which does not assure the arrival of data. Furthermore, the data are transmitted in a packet format defined in this protocol. UDP is an example of this protocol.

In order to enhance reliability in the sense that the transmission target data 103 surely arrive at the transmission-destination computer 102, the transmission-source computer 101 transmits packets 105 and 106 containing the same transmission target data 103 to the transmission-destination computer 102 through plural routes.

The transmission-destination computer 102 executes the processing corresponding to an embodiment by using the transmission target data 103 contained in the received packet. However, it would be wasteful if the transmission-source computer 101 transmitted plural packets containing the same content and the transmission-destination computer 102 duplicatively executed the same processing on all of the packets. Accordingly, it is necessary to make the transmission-destination computer 102 judge the duplication so that when the transmission-destination computer receives a duplicative packet, the duplicative packet is discarded and needless processing can be avoided.

Occasionally an abnormality occurs in all the routes at the same time and all the plural packets are extinguished (lost). Also, plural different packets sometimes arrive at the transmission-destination computer 102 in an order which is different from the transmission order of the plural different packets.

In general, a fixed standby time is required to make a judgment regarding permutation of the order and extinction of data. For example, when a packet A and a packet B are transmitted in this order, but, the packet B is received prior to the packet A, it would be judged that permutation of the order occurred if the packet A is received within the fixed time. If not so, it would be judged on the basis of the time-out that the packet A vanished. Accordingly, the judgment as to the permutation of the order needs a standby time from the reception of the packet B till the reception of the packet A, and a further standby time is required to discriminate between permutation of the order and extinction from each other or loss of the packet.

A method of executing the processing under the condition that the permutation of the order and the extinction are not discriminated from each other and the permutation of the order is regarded as one type of extinction.

In FIG. 1, the transmission-destination computer 102 is designed so that it can judge the duplication and extinction of the packet. Specifically, the transmission-source computer 101 manages transmission order information 104, and transmits the packets 105 and 106 to the transmission-destination computer 102 with the transmission order information 104 is contained in the packets 105 and 106. The transmission-destination computer 102 manages reception order information 111, obtains the transmission order information 109 or 110 from the received packet 105 or 106, and compares the obtained transmission order information 109 or 110 with the order represented by the reception order information 111. As a result of the comparison, the duplication or extinction of the packet is judged. The contents of the transmission order information 109 and 110 is the same as the transmission order information 104.

Only one block representing the transmission target data 103 is shown in FIG. 1. However, under an actual environment, it is typical that various packets corresponding to various data are successively transmitted from the transmission-source computer 101 to the transmission-destination computer 102. The transmission order information 104 represents the transmission order of such different packets, and it contains a number, for example. The turn of a packet is indicated on the basis of the number allocated to the packet concerned. The transmission order information 104 is stored in a storage unit (not shown) provided to the transmission-source computer 101, and read out and updated by a transmission order information updating unit provided to the transmission-source computer 101. For example, the storage unit is implemented by RAM (Random Access Memory), and the transmission order information updating unit is implemented by CPU (Central Processing Unit) for executing a transmission program according to the present invention.

A packet creator (not shown) provided to the transmission-source computer 101 adds the same transmission order information 104 to the same transmission target data 103 to create two packets 105 and 106. A transmitter (not shown) provided to the transmission-source computer 101 transmits the packets 105 and 106 through the routes 107 and 108 to the transmission-destination computer 102. For example, the packet creator is implemented by CPU for executing the transmission program according to the present invention, and the transmitter is implemented by CPU and a communication interface.

When the two routes are normal, a receiver (not shown) of the transmission-destination computer 102 normally receives the packets 105 and 106. A comparing and judging unit (not shown) of the transmission-destination computer 102 judges that the packet 106 is a duplicated packet when receiving the packet 105 earlier than the packet 106. Conversely, when receiving the packet 106 earlier than the packet 105, the comparing and judging unit judges that the packet 105 is a duplicated packet. The receiver is typically implemented by the CPU for executing a reception program according to the present invention and a communication interface, and the comparing and judging unit is implemented by the same CPU.

Duplication of the packet can be identified as described above because the transmission-destination computer 102 manages the reception order information 111. The reception order information 111 is managed on the basis of the transmission order information contained in the packets which were behind (previously received) by the transmission-destination computer 102, and stored in a storage unit (not shown) provided, to the transmission-destination computer 102. The storage unit comprises RAM, for example. The reception order information 111 represents the order in which packets are expected to be received.

In order to make the understanding of the transmission order information 104 and the reception order information 111 easy, they will be described by using a simple example. The transmission order information 104 contains a number representing the turns of successive packets in ascending order, and the turns are represented by numbers. That is, in this example, the packet having the turn following the turn represented by “1” is represented by “2”, and the packet having the turn following the turn represented by “2” is represented by “3”.

The transmission target data 103 out of data transmitted from the transmission-source computer 101 to the transmission-destination computer 102 is assumed to correspond to the turn represented by “2”. Furthermore, it is assumed that another packet corresponding to the turn represented by “1” has been already normally transmitted to the transmission-destination computer 102 and the packet 105 was received prior to the packet 106.

When the transmission order information 104 contains the number of “2”, the comparing and judging unit of the transmission-destination computer 102 can obtain the transmission order information 109 and 110 containing the number of “2” from the received packets 105 and 106, respectively. Furthermore, the transmission-destination computer 102 previously received another packet corresponding to the turn represented by “1”, and thus at the time point when the packet 105 is received, the comparing and judging unit expects that the packet corresponding to the turn represented by “2” will be next received. The information representing the expected turn is the reception order information 111. The reception order information 111 may contain a number representing a turn in ascending order as in the case of the transmission order information 104. For example, the reception order information 111 at this time point may contain the number of “2”.

When the receiver of the transmission-destination computer 102 receives the packet 105 under the above assumption, the turn represented by the transmission order information 109 obtained from the packet 105 is equal to the turn represented by the reception order information 111. This indicates that the packet corresponding to the expected turn is normally received. Accordingly, the transmission-destination computer 102 executes the necessary processing matched with the embodiment by using the transmission target data 103 contained in the packet 105. Furthermore, since the packet 105 is received, the turn corresponding to a packet which is expected to be next received is displaced to the subsequent turn, that is, the turn represented by “3”. Accordingly, a normal processor (not shown) of the transmission-destination computer 102 updates the number contained in the reception order information 111 to “3”. For example, the normal processor is implemented by CPU for executing the reception program of the present invention.

Thereafter, the receiver of the transmission-destination computer 102 receives the packet 106. The transmission order information 110 obtained from the packet 106 contains the number of “2”, and the updated reception order information 111 contains the number of “3”. That is, the transmission order information 110 represents a turn prior to the turn represented by the reception order information 111. Accordingly, the comparing and judging unit of the transmission-destination computer 102 judges that the packet 106 is duplicated with another packet which was previously received. Actually, the packet 106 contains the same transmission target data 103 and the same transmission order information 104 as the packet 105, and thus it is duplicated with the packet 105. In the transmission-destination computer 102, the transmission target data 103 contained in the packet 106 which is judged to be duplicated is not used, but discarded. Accordingly, the same processing on the same data can be avoided from being duplicatively executed and thus needless time required to execute the duplicative processing can be saved.

Next, the extinction of the packet will be described by partially changing the above assumption. First, it is assumed that the packet corresponding to the turn represented by “1” has been normally received by the transmission-destination computer 102 and the packet corresponding to the turn represented by “2” is extinguished in both the routes 107 and 108. At this stage, the packet which is expected to be next received by the transmission-destination computer 102 corresponds to the turn represented by “2”, and thus the reception order information 111 contains the number of “2”.

Thereafter, the transmission-source computer 101 creates the packets 105 and 106 containing the transmission order information 104 and the transmission target data 103 containing the number of “3”, and transmits the packets 105 and 106 to the transmission-destination computer 102 through the routes 107 and 108. In the following description, it is assumed that the packet 105 is received prior to the packet 106.

The comparing and judging unit of the transmission-destination computer 102 obtains the transmission order information 109 from the packet 105. The number of “3” contained in the transmission order information 109 corresponds to a turn which is subsequent to the turn represented by the number “2” contained in the reception order information 111, and thus the comparing and judging unit of the transmission-destination computer 102 can judge that the packet is extinguished.

FIG. 2 is a diagram showing the construction of the duplex system for executing synchronization of data. The duplex system of FIG. 2 is a system in which two computers 201 and 202 each having the same construction are paired and one of them is operated as an active device while the other is operated as a standby device. When trouble occurs in the active device or when it is necessary to exchange the hardware of the active device, the active device is switched to the standby device. By doubling the system as described above, the system is set to be fault-tolerant, and availability of services can be enhanced.

In the following description, data transmission based on UDP is executed for synchronisation of data which is required for the switching operation between the active device and the standby device. By using this invention, instantaneous synchronization of data can be performed in the system of FIG. 2. In the following description, the word “packet” means a UDP packet unless otherwise noted.

FIG. 2 shows a state in which a computer 201 shown at the left side is operated as an active device and a computer 202 shown at the right side is operated as a standby device. The terms “active device” and “standby device” are relative expressions, and if they are required to be switched to each other, the terms are reversed. However, unless otherwise noted, the state of FIG. 2 is assumed, and the two computers are merely expressed as “active device 201” and “standby device 202”. The two computers are expressed as “computer 201” and “computer 202” when it is required to identify the computer itself irrespective of which one of the two computers is operated as the active device.

The active device 201 is a general computer, and it is equipped with a common memory 205 in which data to be synchronized with the standby device 202 are stored, and a CPU (not shown). The common memory 205 is a volatile memory such as RAM or the like, and it has a higher access speed than a non-volatile memory such as a hard disc or the like. The computer 201 is equipped with another memory area (not shown) in which data necessary for the synchronization processing itself are stored. This area will be referred to as “control data area” in the following description. In this embodiment, a part of RAM provided to the computer 201 is used as the common memory 205, and the remaining part is used as a control data area. The transmission order information 104 and the reception order information 111 of FIG. 1 are stored in the control data area. The standby device 202 is provided with the common memory 206 and CPU (not shown), and has the same construction as the active device 201.

The system of FIG. 2 instantaneously synchronizes the data stored in the common memories 205 and 206 to shorten the switching time of the active device 202 and the standby device 202. In this embodiment, each of the common memories 205 and 206 is set so that the same data are stored at all times except for a slight time required for the synchronization. Accordingly, virtually, the active device 201 and the standby device 202 can be regarded as sharing one memory area. Therefore, the common memories 205 and 206 are collectively represented as a virtual common memory 203. Furthermore, the term “common” is appended to the common memories 205 and 206 because they are constituent elements of the virtual common memory 203.

One or more user applications 207 are executed by CPU (not shown) of the active device 201. Accurately, CPU executes various kinds of processing. However, in order to simplify the expression in the following description, an expression “a user application 207 executes processing”, etc. are used in some places.

In addition to OS (Operating System), a middleware group 211 comprising various kinds of middleware mediating OS and a user application 207 is installed in the active device 201. One middleware contained in the middleware group 211 controls the data synchronization using UDP. In FIG. 2, the middleware concerned is represented by a functional block as a common memory controller 213. The middleware for implementing the common memory controller 213 contains the transmission program and the reception program of the present invention.

The active device 201 and the standby device 202 have the same construction. That is, a middleware group 212 is installed in the standby device 202, and the middleware 212 contains a common memory controller 214. The same user application as the user application 207 is also installed in the standby device 202, but, it is not executed in the standby state. Therefore, it is not shown.

The execution of the user application 207 generally accompanies alteration of data of the common memory 205. Accordingly, according to this embodiment, in order to keep the synchronization between the common memories 205 and 206, every time the data of the common memory 205 is altered, the alteration is necessarily reflected to the common memory 206 of the standby device 202. The access speed to the volatile memory area such as the common memories 205 and 206 is higher than the access speed to the non-volatile area such as a hard disc or the like, and thus the reflection or synchronization can be performed at high speed. Furthermore, with respect to data transmission carried out between the active device 201 and the standby device 202 for the reflection concerned, the throughput and the reliability can be enhanced by using the present invention. The high throughput means that the processing speed is high. Finally, the common memories 205 and 206 are very quickly synchronized with each other,

A plurality of communication paths between the active device 201 and the standby device 202 are used for the synchronization between the common memories 205 and 206. The number of the communication paths in this embodiment is equal to 2, and these two communication paths will be referred to as “first route 215” and “second route 216” in the following description. Furthermore, a communication protocol used in this embodiment is UDP, and the communication function based on UDP is generally supplied by OS. Therefore, the common memory controllers 213 and 214 which are implemented by upper middleware of OS can perform communications through the first route 215 or the second route 216 by using UDP.

In FIG. 2, the operation of writing data 209 into the common memory 205 by the user application 207 is represented by “(1) Write”, and it is represented by an arrow from the user application 207 to the common memory 205.

After this writing operation, the user application 207 calls the common memory controller 213 to synchronize the common memories 205 and 206. In FIG. 2, this synchronization processing is expressed by “(2) Commit”. Furthermore, it is expressed by “(3) Wait” in FIG. 2 that the user application 207 waits until the synchronization is finished.

The flow of the processing from “(2) Commit” to “(3) _Wait” in FIG. 2 will be described along arrows as follows.

First, as indicated by a line from the user application 207 to a point A, the user application 207 supplies the common memory controller 213 with the same data as the data 209 written in the common memory 205 by the writing operation of (1). The arrow is branched to two parts at the point A. One part passes through the first route 215 to a point B, and the other part passes through the second route 216 to a point D. This branch represents that the common memory controller 213 transmits a packet containing data 209 through each of the two routes to the standby device 202.

The packets transmitted through the two routes are received by the common memory controller 214 of the standby device 202. In FIG. 2, it is assumed that the packet transmitted through the first route 215 is received earlier than the packet transmitted through the second route 216. The reception of the former corresponds to the point B, and the latter reception corresponds to a point D. At the point B, an arrow is branched to two parts, and subjected to subsequent processing.

On the other hand, the point D is a terminal point. This means that the packet received through the second route 216 is discarded. The packet concerned is discarded because it is judged by the common memory controller 214 that the packet concerned is duplicative with the packet which has been already-received through the first route 215.

One arrow branched at the point B indicates that the data 210 is stored in the common memory 206. This represents that the common memory controller 214 writes the received data into the common memory 206.

Another arrow branched at the point B passes to the point C, and is further branched to two parts at the point C. The point C corresponds to transmission of a message notifying a processing result, specifically, an ACK packet described later from the common memory controller 214 to the active device 201. The branch at the point C represents that the ACK packet is transmitted through the first route 215 and the second route 216.

In FIG. 2, it is assumed that the ACK packet transmitted through the second route 216 is received earlier than the ACK packet transmitted through the first route 215. The former corresponds to an arrow which branches at the point C, passes through the second route 216 and the common memory controller 213 and terminates at the user application 207. The latter corresponds to an arrow which branches at the point C, passes through the first route 215 and terminates at the point E. That is, a notification from the common memory controller 213 to the user application 207 is made on the basis of the ACK packet which is first received by the common memory controller 213. On the basis of the notification, the user application 207 detects that the synchronization between the common memories 205 and 206 is completed, and is released from the waiting state of (3).

The point E indicates that the other ACK packet will be subsequently received by the common memory controller 213. That is, the point E corresponds to the time point after the ACK packet concerning the synchronization of the data 209 is received through the second route 216, and thus the ACK packet which is received second at the point E is unnecessary. Accordingly, the common memory controller 213 neglects this unnecessary ACK packet.

As described above, every time the user application 207 writes the data 209 into the common memory 205, the data 210 having the same content are also written into the common memory 206, and the common memories 205 and 206 are synchronized with each other.

Furthermore, the communication protocol used for this synchronization is UDP, and thus the time required for data transmission for the purpose of the synchronization is shorter than the case where TCP is used. Furthermore, it is very rare that troubles occur in the two different routes of the first and second routes 215 and 216 at the same time, so that the data synchronization can be substantially surely established.

Furthermore, even when trouble occurs in any one of the first and second routes 215 and 216, data which are normally received through the normal route are written into the common memory 206 by the common memory controller 214, thereby establishing the synchronization. That is, in a case where the time dispersion between transmission times through the respective routes is extremely large, even if trouble occurs in one of the routes, the synchronization timing is not so greatly delayed as compared with the synchronization timing when both the routes are normal. This point contributes to the feature that the data synchronization speed is high.

Next, examples of data transfer control tables 301 and 302 managed by the computers 201 and 202 of FIG. 2 respectively will be described. As shown in FIG. 3, the data transfer control tables 301 and 302 are based on the same format, and stored in a control data area on RAM, for example.

The contents of the data transfer control tables 301 and 302 are not relevant to which one of the computers 201 and 202 is acting as the active device. That is, the data transfer control tables 301 and 302 do not assume the state of FIG. 2. Accordingly, in the description of FIG. 3, they are not expressed as “active device 201” and “standby device 202”, but expressed as “computer 201” and “computer 202”.

The data transfer control table 301 has fields of “self IP address”, “IP address of communication partner”, “self port number”, “port number of communication partner” and “state” for each of the first and second routes 215 and 216. The data transfer control table 302 has the same format.

In the communication using UDP, the transmission destination and the transmission source are represented by a socket address corresponding to the pair of the IP address and the port number. Accordingly, the end point at the computer 201 side of the first route 215 is “192.168.1.100:6100] corresponding to the pair of “self IP address” and “self port number” of the data transfer control table 301. Conversely, this socket address is represented by the pair of “IP address of communication partner” and “port number of communication partner” in the data transfer control table 302.

On the other hand, the end point at the computer 202 side of the first route 215 is “192.168.1.200:6200” corresponding to the pair of “IP address of communication partner” and “port number of communication partner” of the data transfer control table 301. The socket address is represented by the pair of “self IP address” and “self port number” in the data transfer control table 302.

The “state” of the data transfer control table 301 and 302 takes a value of “normal” or “abnormal”. The value of “state” of the data transfer control table 301 is dynamically rewritten in accordance with the monitoring results of the first route 215 and the second route 216. The same is applied to the data transfer control table 302.

In the example of FIG. 3, the first route 215 is defined by two socket addresses of “192.168.1.100:6100” and “192.168.1.200:6200”, and the second route 216 is defined by two socket addresses of “10.1.1.100:7100” and “10.1.1.200:7200”. That is, the IP address and the port number are different between the first route 215 and the second route 216.

For example, two NICs (Network Interface Card) are secured to the computer 201, and different. IP addresses are allocated to the respective NICs, whereby the two different IP addresses can be allocated to one computer 201 in the example of FIG. 3. Furthermore, it is desirable that physical media such as a cable, etc. are different between the first route 215 and the second route 216.

The IP address at the computer 201 side of the first route 215 or the second route 216 may be the same. For example, even in the case of the same IP address, the two routes can be isolated from each other by using different port numbers.

Furthermore, even in the case of the setting as shown in FIG. 3, the physical medium itself of the route can be shared by the first route 215 and the second route 216. For example, the computers 201 and 202 may be connected to each other through one switching hub, and each of the computers 201 and 202 and the switching hub may be connected to each other through one cable. However, when plural routes share a physical medium as described above, the traffic amount of one medium is increased, and thus data collision easily occurs, so that the overall processing speed may be reduced. Accordingly, it is desired to implement different routes by different physical media.

FIG. 4 is a block diagram showing threads constituting middleware for implementing the common memory controllers 213 and 214. According to this embodiment, as shown in FIG. 2, the computers 201 and 202 have the same construction, and the active device and the standby device can foe switched to each other. Accordingly, the common memory controller 213 is required to have a function of transmitting data to the computer 202 for a case where the computer 201 is applied as an active device, and also a function of receiving data from the computer 202 and reflecting the data to the common memory 205 for a case where the computer 201 is operated as a standby device. The same is also applied to the common memory controller 214.

Specifically, the common memory controllers 213 and 214 are designed so that the data transmission to the first route 215 and the data reception from the first route 215 can be performed through UDP ports 411 and 412. Furthermore, the common memory controllers 213 and 214 are designed so that the data transmission to the second route 216 and the data reception from the second route 216 can be performed through UDP ports 413 and 414.

The middleware for implementing the common memory controllers 213 and 214 is a multi-thread program in the embodiment of FIG. 4. Specifically, CPU (not shown) of the computer 201 executes a health check thread 401, a data transmission thread 403, a data reception thread 405, a first route reception thread 407 and a second route reception thread 409 to thereby implement the common memory controller 213. Likewise, CPU (not shown) of the computer 202 executes a health check thread 402, a data transmission thread 404, a data reception thread 406, a first route reception thread 408 and a second route reception thread 410 to thereby implement the common memory controller 214.

The common memory controller 213 will be described hereunder, and the same is applied to the common memory controller 214.

The health check thread 401 monitors the states of the first route 215 and the second route 216. Specifically, the health check thread 401 judges the state of the route on the basis of the reception interval of packets for monitoring the state of the route which are transmitted from the computer 202 at a fixed interval. The monitoring packets will be referred teas “health check packets” hereunder, and the specific format thereof will be described later with reference to FIG. 5.

The interval h1 at which the health check packets are transmitted from the computer 202 is predetermined, and for example, h1 is set to 1 second. The health check packets transmitted from the computer 202 through the first route 215 are received by the first route reception thread 407. When receiving the health check packets, the first route reception thread 407 notifies the reception of the health check packet to the health check thread 401.

The health check thread 401 checks the interval h between the present notification and the previous notification from the first route reception thread 407. If the interval h is within a predetermined time h2, the health check thread 401 sets the value of the “state” field of the “first route” record of the data transfer control table 301 to “normal”, and if not, it sets the value concerned to “abnormal”. The predetermined time h2 is a value indicating the permissible range in which the state of the route can be regarded as being normal, and it is set to a slightly larger value than the predetermined transmission interval h1 of the health check packets. It is desired that the transmission interval h1 and the predetermined interval h2 be set to proper values from experiments or the like.

Likewise, with respect to the second route 216, the health check thread 401 monitors the state, and the monitoring result is reflected to the data transfer control table 301.

In the computer 202, specifically, the health check thread 402 transmits the health check packets to the computer 201. The health check thread 402 generates health check packets addressed to “IP address of communication partner” and “port number of communication partner” for the first route 215 and the second route 216 by referring to the data transfer control table 302. The health check thread 402 transmits the generated health check packets from the UDP port 412 to the first route 215 and also from the UDP port 414 to the second route 216.

The health check thread 402 also monitors the states of the first route 215 and the second route 216 according to the same method as described above, and dynamically sets the value of the “state” field of the data transfer control table 302. The health check thread 401 also transmits the health check packets through the two routes to the computer 202 at the transmission interval h1 so that the health check thread 402 can monitor the states of the first route 215 and the second route 216.

That is, in this embodiment, irrespective of which one of the computers 201 and 202 operates as the active device, both the health check threads 401 and 402 transmit the health check packets and the active device monitors the state of the route on the basis of the reception interval h of the health check packets.

When the data transmission thread 403 is applied as the active device, the transmission target data, that is, the data 209 written in the common memory 205 are transmitted to the computer 202 which is operated as the standby device. The data 209 corresponds to the transmission target data 103 of FIG. 1. The data 209 are transmitted, in the format of the UDP packet. The UDP packet will be hereunder referred to as “common memory data packet”, and the format thereof will be described later with reference to FIG. 5. The common memory data packet corresponds to the packets 105 and 106 of FIG. 1.

When the computer 201 is operated as the standby device, the data transmission thread 403 transmits to the computer 202 an arrival acknowledge to a packet transmitted from the computer 202 operated as the active device. Specifically, this arrival acknowledge is one type of UDP packet, and it will be hereunder referred to as “ACK packet”. The format of the ACK packet will be described in detail later with reference to FIG. 5.

In any case, the data transmission thread 403 generates a UDP packet to be transmitted, more accurately, an IP packet obtained by encapsulating the UDP packet concerned. When it is generated, the data transmission thread 403 refers to the data transfer control table 301 to set the IP addresses and the port numbers of the transmission source and the transmission destination. Furthermore, the data transmission thread 403 refers to the data transfer control table 301, and transmits the generated packet from only the route in which the value of the “state” field is “normal”.

The data transmission thread 404 in the common memory controller 214 is the same as the data transmission thread 403.

The data reception thread 405 properly processes the data received by the first route reception thread 407 and the second route reception thread 409. Specifically, the data reception thread 405 processes various kinds of control packets transmitted from the computer 202 irrespective of whether the computer 201 is operated as the active device or not. Furthermore, when the computer 201 is operated as the standby device, the data reception thread 405 further processes the common memory data packet. This processing contains a judging operation of judging duplication and extinction of a common memory data packet, a reflection operation of reflecting the content of a non-duplicated common memory data packet to the common memory 205 and a request operation of requesting the data transmission thread 403 to transmit an ACK packet as occasion demands.

The first route reception thread 407 waits for a packet in which the values of “self IP address” and “self port number” of the “first route” record in the data transfer control table 301 are indicated as an address. That is, the first route reception thread 407 monitors transmission of a packet to the UDP port 411 through the first route 215 at all times, and receives the transmitted packet. Then, the first route reception thread 407 judges whether the received packet is a health check packet or not. If the received packet is a health check packet, the first route reception thread 407 notifies the reception of the health check packet to the health check thread 401, and if not so, it requests the processing of the received packet to the data reception thread 405.

Likewise, the second route reception thread 409 waits for a packet in which the values of “self IP address” and “self port number” of the “second route” record of the data transfer control table 301 are indicated as an address. The second route reception thread 409 judges whether the received packet is a health check packet or not. If the received packet is a health check packet, the second route reception thread 409 notifies the reception of the health check packet to the health check thread 401, and if not so, it requests the processing of the received packet to the data reception thread 405.

The same is applied to the data reception thread 406, the first route reception thread 408 and the second route reception thread 410 of the common memory controller 214.

The reason why the three threads of the data reception thread 405, the first route reception thread 407 and the second route reception thread 409 are provided with respect to the reception, but only the data transmission thread 403 is provided with respect to the transmission resides in that FIG. 3 is the diagram showing the threads. Since it is unclear when a packet is received, the first route reception thread 407 for monitoring the UDP port 411 at all times, the second route reception thread 409 for monitoring the UDP port 413 at all times and the data reception thread 405 for executing the substantial processing associated with the received packet are separated from one another. On the other hand, when packets are transmitted, all of the transmission timing, the UDP port of the transmission source and all packets to be transmitted are grasped by the data transmission thread 403. Accordingly, it is easy and natural for only the data transmission thread 403 to execute the operations from the creation of packets to be transmitted till the actual transmission thereof.

Next, the format of various kinds of packets used in this embodiment will be described with reference to FIG. 5. As described above, UDP is used as the communication protocol in this embodiment. As well known, the UDP packet comprises a UDP header and an optional payload portion, and the UDP header contains the port numbers of the transmission source and the transmission destination. All five kinds of packets shown in FIG. 5 are UDP packets, and unique fields inherent to this embodiment are provided in the payload portions. The five kinds of packets shown in FIG. 5 are identified on the basis of the values of these unique fields.

Specifically, a health check packet 501 contains only a field of “TYPE1” in the payload portion, and the value thereof is equal to “1” as indicated in a parenthesis in this embodiment. Each of a refresh request packet 502 and a refresh acknowledge packet 503 contains three fields of “TYPE1”, “TYPE2” and “refresh ID” in the payload portion. The roles of the refresh request packet 502 and the refresh acknowledge packet 503 will be described later. A common memory data packet 504 contains five fields of “TYPE1”, “TYPE2”, “refresh ID”, “serial number” and “common memory data” in the payload portion. An ACK packet 505 contains four fields of “TYPE1”, “TYPE2”, “refresh ID” and “serial number” in the payload portion. The length of each field may be properly determined in accordance with the embodiment.

TYPE1 and TYPE2, are fields indicating the types of packets. TYPE1 represents an upper classification, and TYPE2 represents a lower classification. In FIG. 5, examples of values are indicated in parentheses, and as is apparent from these values, the five packets are classified into two types of the health check packet 501 and the other packets in accordance with the value of the TYPE1 field. The latter packets are further classified into four types in accordance with the value of the TYPE2 field.

The first and second route reception threads 407 to 410 of FIG. 4 check only the UDP header and the TYPE1 field. If the UDP header is proper and the value of the TYPE1 field is equal to 1, the first and second route reception threads 407 to 410 judge that the received packet is the health check packet 501, and notifies the reception of the health check packet 501 to the health check thread 401 or 402.

On the other hand, if the UDP header is proper, and the value of the TYPE1 field is equal to 2, the first and second route reception threads 407 to 410 judge that the received packet is a packet other than the health check packet 501, and requests the processing of the received packet to the data reception thread 405 or 406. The data reception thread 405 or 406 processes only packets whose types are different from the health check packet 501. The data reception threads 405 and 406 identify the type of the packet on the basis of the value of the TYPE2 field, and execute the processing corresponding to the packet type.

The values of the refresh ID field and the serial number field are set by the data transmission threads 403 or 404. The information achieved by combining the values of these two fields corresponds to the transmission order information 104 of FIG. 1.

The common memory data field is contained in only the common memory data packet 504. In FIG. 5, the embodiment in which the data for the data synchronization between the common memories 205 and 206 are transmitted as shown in FIG. 2 is assumed. Therefore, the word “common memory data” is used for the names of the packet type and the field. However, generally describing, the content of the common memory data field is the data of the transmission target itself, the common memory data packet 504 is a packet for transmitting the data of the transmission target, and the other types of packets are packets for various control. That is, the content of the common memory data field corresponds to the transmission target data 103 of FIG. 1.

Next, the operation of each of the threads described above will be described with reference to the flowcharts of FIGS. 6 to 9. With respect to FIGS. 6 to 9, the description will be made on the assumption of the state of FIG. 2 under which the computer 201 is operated as the active device and the computer 202 is operated as the standby device.

FIG. 6 is a flowchart showing the common memory data transmission processing for transmitting the common memory data packet 504 to the standby device 202 by the common memory controller 213. The common memory data transmission processing corresponds to the arrow from the user application 207 to the point A, branches at the point A and then directs to the points B and D in FIG. 2. That is, the timing of starting the common memory data transmission processing resides in that the user application 207 requests the common memory controller 213 to reflect the same data 209 as written in the common memory 205 to the common memory 206 of the standby device 202.

In step S101, the data transmission thread 403 creates two common memory data packets 504 to be transmitted through the first route 215 and the second route 216. In the following description, reference numerals “504-1” and “504-2” are used when it is necessary to discriminate the two common memory data packets 504 from each other. The transmission serial number field of the serial number managing table 601 is updated in the process of creating the common memory data packets 504-1 and 504-2.

For example, the serial number managing table 601 (see 601a and 601b in FIG. 6) is stored in a control data area on RAM which can be referred to by the common memory controller 213, and holds information for managing the order of the common memory data packet 504. Specifically, the serial number managing table 601 has the fields of “transmission serial number”, “reception serial number” and “refresh ID”. In this embodiment, each of the transmission serial number and the reception serial number is an integer of 0 to 255 which is represented by one byte, and the refresh ID is a value representing the data. In this embodiment, with respect to the three fields, exceptional initial values thereof before they are initialized to effective values are set to zero, and the details will be described later. FIG. 6 shows two states of the serial number managing table 601 while they are discriminated from each other by using reference numerals “601a” and “601b”.

Although described in detail later, it must be determined on the basis of the common memory data packet 504 that the transmission serial number of “1” which is used the second time indicates a turn subsequent to the turn indicated by the transmission serial number of “255” which is used the first time. The refresh ID is identification information for identifying the reused transmission serial numbers having the same values.

In step S101, the data transmission thread 403 updates the transmission serial number field of the serial number managing table 601 to set the transmission serial number to the value achieved by adding the present value with “1”. That is, every time the transmission of the common memory data packet is requested by the user application 207, the transmission serial number is counted up. The data transmission thread 403 sets the updated transmission serial number to the serial number fields of the common memory data packets 504-1 and 504-2.

Furthermore, the data transmission thread 403 reads out the self port number and the port number of the communication partner from the “first route” record in the data transfer control table 301, and sets the read-out port numbers to the UDP header of the common memory data packet 504-1 to be transmitted through the first route 215. Likewise, the data transmission thread 403 reads out the self port number and the port number of the communication partner from the “second route” record, and sets the read-out port numbers to the UDP header of the common memory data packet 504-2 to be transmitted through the second route 216.

The respective fields of TYPE1, TYPE2, the refresh ID and the common memory data are common between the common memory data packets 504-1 and 504-2. That is, as shown in FIG. 5, the data transmission thread 403 sets TYPE1 to 2 and sets TYPE2 to 3. Furthermore, the data transmission thread 403 reads out the refresh ID from the serial number managing table 601, and sets it to the refresh ID fields of the common memory data packets 504-1 and 504-2. The content of the common memory data field is the data which is supplied to the common memory controller 213 by the user application 207 during the common memory data transmission processing, and it is equal to the data 209.

The foregoing processing is the processing of the step S101. However, more particularly, the update processing of the transmission serial number is not the simple increment, but it is the following processing.

In this embodiment, it is assumed that when the computer 201 is powered or re-started, all the values of the three fields of the serial number managing table 601 are automatically set to zero, and the state of the serial number managing table 601a of FIG. 6 is set. That is, in this embodiment, the value of 0 is an exceptional value before it is initialized to an effective value. At the first transmission time of the common memory data packet 504 after the power is turned on or after the re-start, the transmission serial number in step S101 is set to 1.

As described above, the transmission serial number is an integer from 0 to 255. Accordingly, the transmission serial number overflows if common memory data packets 504 whose number is larger than 255 are transmitted. Therefore, it is necessary to reuse the same number. When the present transmission serial number is equal to 255, by merely adding “255” with “1”, the transmission serial number is updated to a value of 0 as a result of the overflow. However, 0 is an exceptional value before initialization, and thus 0 should not be set to the serial number field of the common memory data packet 504.

Therefore, in the update processing of the transmission serial number in step S101, the data transmission thread 403 first sets the transmission number to the value attained by adding the present value with “1”. If the addition result provides the transmission serial number of 0, the data transmission thread 403 adds the transmission serial number with “1” again. The data transmission thread 403 sets the thus-obtained transmission serial number of “1” to the serial number field of the common memory data packet 504. Therefore, the value of the serial number field of the common memory data packet 504 to be transmitted just after the common memory data packet 504 in which the value of the serial number field is equal to 255 is equal to 1.

As described above, when the common memory data packets 504-1 and 504-2 in which any value of 1 to 255 is set in the serial number field are created in step S101, the data transmission thread 403 judges in step S102 whether the transmission serial number stored in the serial number managing table 601 is equal to 1 or not. If the transmission serial number is equal to 1, the judgment is “YES”, and the processing goes to step S103. In the other cases, the judgment is “NO”, and the processing goes to step S106.

The steps S103 to S105 are executed only when the judgment of the step S102 is “YES”. In step S103, the data transmission thread 403 obtains the present date, and registers a value A representing the obtained date into the refresh ID field of the serial number managing table 601. The result is shown in the serial number managing table 601b of FIG. 6.

In subsequent steps S104, the data transmission thread 403 creates two refresh request packets 502 to be transmitted through the first route 215 and the second route 216, and transmits them to the standby device 202. In the following description, when it is necessary to discriminate the two refresh request packets 502, reference numerals of “502-1” and “502-2” are used. The processing of step S104 is the processing of initializing the transmission serial number, the reception serial number and the refresh ID in a cooperative way between the active device 201 and the standby device 202.

The data transmission thread 403 reads the self port number and the port number of the communication partner from the “first route” record and the “second route” record of the data transfer control table 301, and sets them to the UDP headers of the refresh request packets 502-1 and 502-2. The three fields of TYPE1, TYPE2 and the refresh ID are common between the refresh request packets 502-1 and 502-2. The data transmission thread 403 sets TYPE1 to 2, sets TYPE2 to 1, reads out the refresh ID from the serial number managing table 601 and sets the refresh ID to the refresh ID fields of the refresh request packets 502-1 and 502-2.

The data transmission thread 403 refers to the data transfer control table 301 to check the states of the first and second routes 215 and 216. The data transmission thread 403 transmits the refresh request packet 502-1 to the standby device 202 through the first route 215 if the first route 215 is normal. Furthermore, the data transmission thread 403 transmits the refresh request packet 502-2 to the standby device 202 through the second route 216 if the second route 216 is normal.

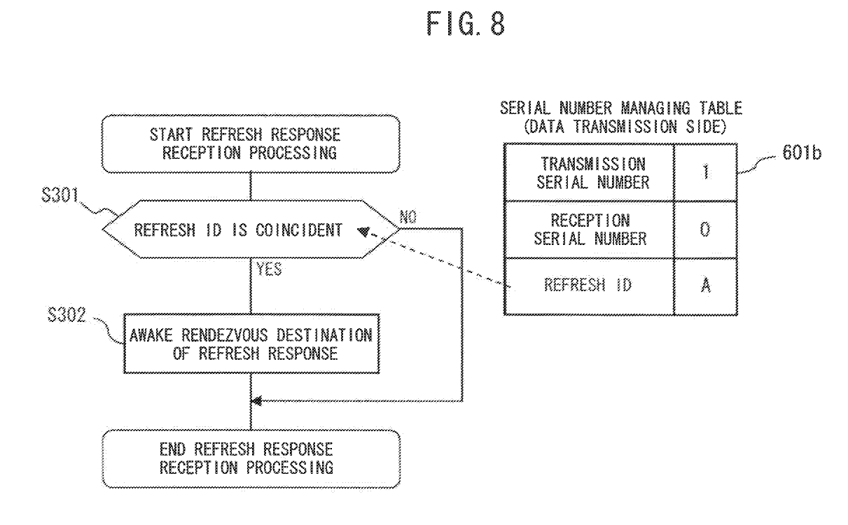

In subsequent step S105, the data transmission thread 403 is set to a sleep state, and the data reception thread 405 waits for an acknowledge from the standby device 202, that is, the reception of the refresh acknowledge packet 503. The details of the reception of the refresh acknowledge packet 503 will be described later with reference to FIG. 8. The data transmission thread 403 under the sleep state awakened with the reception of the refresh acknowledge packet 503 as a trigger, and the processing shifts to the step S106.

In step S106, the data transmission thread 403 refers to the “state” field of the “first route” record of the data transfer control table 301, and judges whether the first route 215 is normal or not. If the value of the “state” field is “normal”, the judgment is “YES”, and the processing goes to step S107. If not so, the judgment is “NO”, and the processing shifts to step S108.

In step S107, the data transmission thread 403 first reads out the self IP address and the IP address of communication partner of the “first route” record of the data transfer control table 301. Then, the data transmission thread 403 adds the common memory data packet 504-1 with the IP header containing the read-out IP addresses, and encapsulates the common memory data packet 504-1. The data transmission thread 403 transmits the encapsulated IP packet from the UDP port 411 through the first route 215 to the standby device 202.

The processing comprising subsequent steps S108 and S109 is the same as the processing comprising the steps S106 and S107. The difference point resides only in that the steps S106 and S107 are the processing corresponding to the first route 215 whereas the steps S108 and 109 are the processing corresponding to the second route 216.

After “NO” is judged in step S108 or the step S109 is executed, the common memory data transmission processing of FIG. 6 is finished.

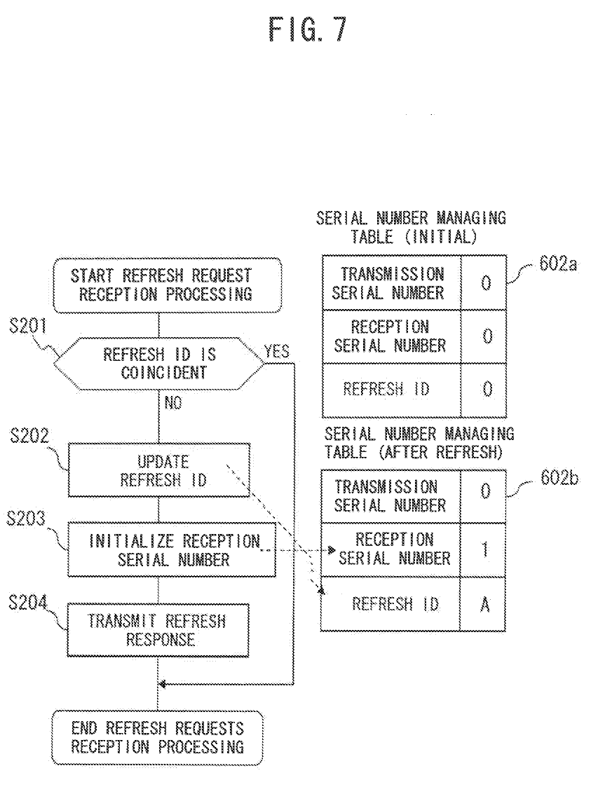

FIG. 7 is a flowchart showing the refresh request reception processing in which the refresh request packet 502 transmitted in step S104 of FIG. 6 is received by the standby device 202.

First, the first route reception thread 408 or the second route reception thread 410 receives a packet, judges on the basis of the value of the TYPE1 field that the packet is not the health check packet 501, and requests the processing of the received packet to the data reception thread 406. Subsequently, the data reception thread 406 judges on the basis of the value of the TYPE2 field of the received packet that the received packet is the refresh request packet 502. The refresh request reception processing is started with this judgment as a trigger. The refresh request reception processing is executed irrespective of the route through which the refresh request packet 502 is received.

Furthermore, the serial managing table 602 similar to the serial number managing table 601 is also stored in the control data area in the RAM of the computer 202. In FIG. 7, the two states of the serial number managing table 602 are illustrated as being discriminated from each other by reference numerals “602a” and “602b”. All the values of the three fields are equal to zero as in the case of the serial number managing table 602a just after the computer 202 is powered or just after the computer 202 is re-started.

When the refresh request reception processing is started, in step S201, the data reception thread 406 first judges whether the value of the refresh ID field of the received refresh request packet 502 is coincident with the value of the refresh ID field of the serial number managing table 602. If both the values are coincident with each other, the judgment is “YES”, and the refresh request reception processing is finished. If not so, the judgment is “NO”, and the processing shifts to the step S202. The judgment is “YES” when the refresh request packet 502 having the same content as the processed refresh request packet 502 is received through another route.

In step S202, the data reception thread 406 sets the value of the refresh ID field of the received refresh request packet 502 to the refresh ID field of the serial number managing table 602, thereby updating the value of the refresh ID field of the serial number managing table 602. In FIG. 7, the value of the refresh ID field after updating is represented by “A” as in the case of FIG. 6.

In subsequent step S203, the data reception thread 406 initializes the value of the reception serial number field of the serial number managing table 602 to 1. The result is shown as the serial number managing table 602b as shown in FIG. 7. The data reception thread 406 requests the data transmission thread 404 to execute the processing of the next step S204.

In step S204, the data transmission thread 404 creates two refresh acknowledge packets 503 to be transmitted through the first route 215 and the second route 216, and transmits them to the active device 201. In the following description, when it is necessary to discriminate the two refresh acknowledge packets 503 from each other, reference numerals “503-1” and “503-2” are used.

The data transmission thread 404 reads out the self port number and the port number of communication partner from the “first route” record and the “second route” record of the data transfer control table 302, and sets them to the UDP headers of the refresh acknowledge packets 503-1 and 503-2, respectively. The three fields of TYPE1, TYPE2 and the refresh ID are common between the refresh acknowledge packets 503-1 and 503-2. The data transmission thread 404 sets TYPE1 to 2, sets TYPE2 to 2 and sets the refresh ID read out from the refresh request packet 502 in step S201 to the refresh ID fields of the refresh acknowledge packets 503-1 and 503-2. Furthermore, the data transmission thread 404 refers to the self IP address and the IP address of the communication partner of the data transfer control table 302, and adds a proper IP header to the refresh acknowledge packets 503-1 and 503-2.

The data transmission thread 404 refers to the data transfer control table 302 to check the states of the first route 215 and the second route 216. The data transmission thread 404 transmits the refresh acknowledge packet 503-1 to the active device 201 through the first route 215 when the first route 215 is normal, and transmits the refresh acknowledge packet 503-2 to the active device 201 through the second route 216 when the second route 216 is normal.

The refresh request reception processing is finished as described above. If at least one of the first route 215 and the second route 216 is normal, the refresh acknowledge packet 503 transmitted in step S204 is thereafter received by the active device 201. When receiving the refresh acknowledge packet 503, the first route reception thread 407 or the second route reception thread 409 judges that the packet is not the heath check packet 501, and requests the processing of the received packet to the data reception thread 405. The data reception thread 405 judges on the basis of the value of the TYPE2 field of the received packet that the received packet is the refresh acknowledge packet 503. The refresh acknowledge reception processing shown in the flowchart of FIG. 8 is started with the above judgment as a trigger. The refresh acknowledge reception processing is executed irrespective of the route through which the refresh acknowledge packet 503 is received.

The refresh acknowledge reception processing is executed during the waiting period of the step S105 of FIG. 6, and thus the serial number managing table 601b under the same state, as the serial number managing table 601b of FIG. 6 is shown in FIG. 8.

In step S301, the data reception thread 405 reads out the refresh ID from the received refresh acknowledge packet 503, and judges whether the read-out refresh ID is coincident with the refresh ID of the serial number managing table 602. If both the refresh IDs are coincident with each other, the judgment is “YES”, and the processing shifts to step S302. If not, the judgment is “NO” and the refresh acknowledge reception processing is finished. The judgment of “NO” is made in such an exceptional cases such as where a refresh acknowledge packet 503 corresponding to a different refresh ID is transmitted close in time and thus refresh acknowledge packets are received in an order different from the transmission order for some reason, or the like.

In step S302, the data reception thread 405 awakens the data transmission thread 403 as a waiting destination of the received refresh acknowledge packet 503. That is, the data reception thread 405 notifies to the data transmission thread 403 continuing to wait in step S105 of FIG. 6 that the data transmission thread 403 concerned should go to the next step S106, and then the refresh acknowledge reception processing is finished. That is, this awaking notification is a notification indicating that the processing of synchronizing the refresh IDs held in the serial number managing table 601 of the active device 201 and the serial number managing table 602 of the standby device 202.

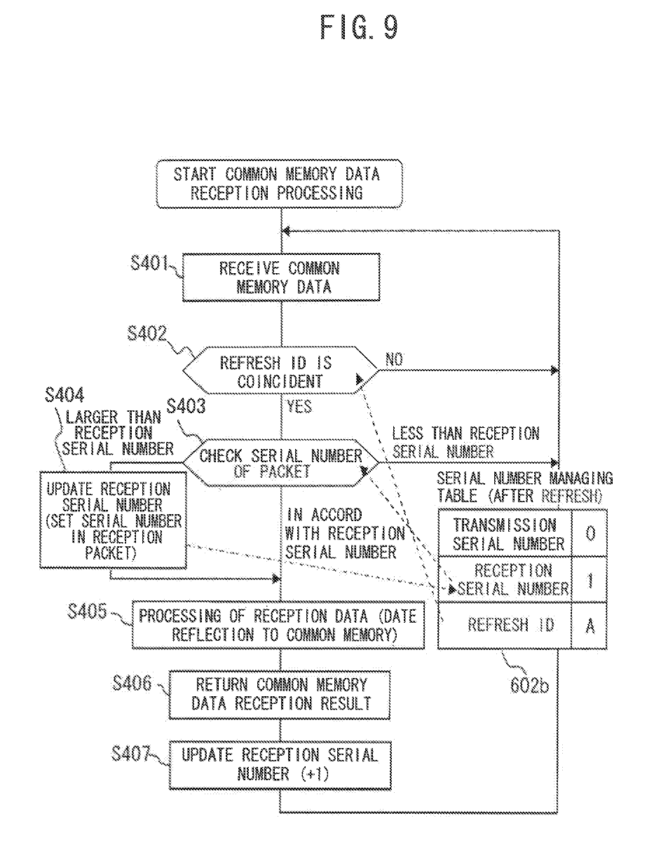

Next, the common memory data reception processing of receiving the common memory data packet 504 by the standby device 202 will be described with reference to FIG. 9. The whole of FIG. 9 constitutes a loop. FIG. 9 shows that every time the common memory data packet 504 is received in step S401, the processing of the steps S402 to S407 is executed, and the processing returns to the step S401 to prepare for the reception of the next common memory data packet 504.

In step S401, the standby device 202 receives the common memory data packet 504. Specifically, in step S107 of FIG. 6, the common memory data packet 504-1 transmitted through the first route 215 in step S107 of FIG. 6 is received by the first route reception thread 408, or the common memory data packet 504-2 transmitted through the second route 215 is received by the second route reception thread 410 in step S103.

The first route reception thread 408 or the second route reception thread 410 judges on the basis of the value of the TYPE1 field of the received packet that the received packet is not the health check packet 501, and requests processing of the received packet to the data reception thread 405. The data reception thread 406 judges on the basis of the value of the TYPE2 field of the received packet that the received packet is the common memory data packet 504. The following processing is executed irrespective of the route through which the common memory data packet 504 is received.

In the next step S402, the data reception thread 406 reads out the refresh ID from the received common memory data packet 504, and judges whether the read-out refresh ID is coincident with the refresh ID of the serial number managing table 602. If both the refresh IDs are coincident with each other, the judgment is “YES”, and the processing is shifted to step S403. If not so, the judgment is “NO” and the processing returns to the step S401.

The judgment of “NO” means that the common memory data packet 504 received in the just-before step S401 is duplicated with another common memory data packet 504 which was previously received. In other words, the judgment of “NO” means that the reception order information 111 of FIG. 1 indicates a turn subsequent to that of the transmission order information 109 or 110. Accordingly, when the judgment is “NO”, the processing concerning the content of the common memory data filed of the common memory data packet 504 received in the just-before step S401 is not executed. That is, the common memory data packet 504 is discarded.

In step S403, the data reception thread 406 reads out the value p of the serial number field of the received common memory data packet 504, and compares it with the value t of the reception serial number field of the serial number managing table 602. The processing is branched into three processes in accordance with the comparison result.

for p<t (1)

The case of p<t corresponds to a case where a common memory data packet 504 having the same content as a common memory data packet which was previously received and processed is duplicatively received through a different route. That is, one of the two common memory data packets 504 created together in step S101 of FIG. 6 was previously received in the loop of FIG. 9 and processed, and the other common memory data packet is received in step S401 of the present loop, so that p<t is satisfied. The equation of “p<t” corresponds to the situation that the reception order information 111 of FIG. 1 indicates a turn subsequent to that of the transmission order information 109 or 110.

With respect to the two common memory data packets 504 created together in step S101 of FIG. 6, the contents of all the fields thereof are identical between them except for the UDP header. The common memory data of the common memory data packet 504 which was previously received had been processed, and thus it is unnecessary to process the common memory data of the common memory data packet 504 which is received in the present loop. Therefore, the common memory data packet 504 received in the step S401 of the present loop is discarded, and the processing concerning the content of the common memory data field is not executed. The processing returns to the next step S401 to wait for reception of the next common memory data packet 504.

for p=t (2)

The case of p=t corresponds to a case where the common memory data packet 504 to be next processed is received. In this embodiment, “to be processed” means that the processing of reflecting the content of the common memory data field to the common memory 206 should be executed. In this case, the processing shifts to the step S405 to execute the processing concerned. That is, “p=t” corresponds to a case where a packet corresponding to a turn which is expected to be next received is just received in the present loop, and the reception order information 111 of FIG. 1 indicates the same turn as the transmission order information 109 or 110.

for p>t (3)

The case of p>t corresponds to a case where one or more plural common memory data, packets 504 which are sequentially transmitted from the active device 201 and correspond to different turns does not arrive at the standby device 202 for some reason. That is, in the case of p>t, when viewed from the standby device 202, some of the plural sequential common memory data packets 504 are extinguished. The equation of “p>t” corresponds to the situation that the reception order information 111 of FIG. 1 indicates a turn preceding that of the transmission order information 109 or 110.

Even when one of the two common memory data packets 504 transmitted through the two routes is extinguished, p>t would not be satisfied and thus it is not regarded as “extinction” if the other common memory data packet 504 arrives at the standby device 202 through the normal route in the correct order. In the case of p>t, the processing shifts to the step S404.

The step S404 is executed when the value p of the serial number field of the received common memory data packet 504 is larger than the value t of the reception serial number field of the serial number managing table 602. In this case, one or more plural common memory data packets 504 which are sequentially transmitted from the active device 201 and correspond to a different order are not received by the standby device 202 in the correct order and thus are missing. However, the common memory data packet 504 received in the step S401 of the present loop contains non-processed data in the common memory data field. In this embodiment, this non-processed data is the data to be processed, and thus it is not discarded, but used.

Therefore, in step S404, it is also reflected to the serial number managing table 602 by the data reception thread 406 that the common memory data packet 504 received in the step S401 of the present loop is a processing target. Specifically, the data reception thread 406 sets the value of the serial number field of the common memory data packet 504 received in the step S401 of the present loop to the reception serial number field of the serial number managing table 602. Accordingly, in the next loop, the judgment of the step S403 is carried out on the basis of the thus-updated reception serial number.

After the step S404 is executed or when p=t is judged in step S403, the steps S405 to S407 are executed.

In step S405, the content of the common memory data field of the common memory data packet 504 received in the step S401 of the present loop is reflected to the common memory 206 by the data reception thread 406. The step S405 corresponds to the arrow directing from the point B to the common memory 206 in FIG. 2. After the processing of the step S405 is finished, the data reception thread 406 requests the data transmission thread 404 to execute the processing of the step S406.

In step S406, the data transmission thread 404 returns an ACK packet 505 to the active device 201. The ACK packet 505 is a packet for notifying to the active device 201 a result that the standby device 202 receives the common memory data packet 504 and the content of the common memory data field is reflected to the common memory 206. The data transmission thread 404 creates two ACK packets 505 to be transmitted through the first route 215 and the second route 216, and transmits the ACK packets to the active device 201. In the following description, reference numerals of “505-1” and “505-2” are used when the two ACK packets 505 are required to be discriminated from each other.

The data transmission thread 404 reads out the self port number and the port number of communication partner from the “first route” record and the “second route” record of the data transfer control table 302, and sets them to the UDP headers of the ACK packets 505-1 and 505-2. The four fields of TYPE1, TYPE2, the refresh ID and the serial number are common between the ACK packets 505-1 and 505-2. The data transmission thread 404 sets TYPE1 to 2, sets TYPE2 to 4, reads the refresh ID from the serial number managing table 602 and sets the read-out refresh ID to the refresh ID fields of the ACK packets 505-1 and 505-2. Furthermore, the data transmission thread 404 refers to the self IP address and the IP address of communication partner of the data transfer control table 302 to add proper ID headers to the ACK packets 505-1 and 505-2.

The data transmission thread 404 refers to the data transfer control table 302 to check the states of the first and second routes 215 and 216. The data transmission thread 404 transmits the ACK packet 505-1 through the first route 215 to the active device 201 when the first route 215 is normal, and transmits the ACK packet 505-2 through the second route 216 to the active device 201 when the second route 216 is normal.

In subsequent step S407, the data reception thread 406 updates the reception serial number field of the serial number managing table 602, and sets the reception serial number of the value achieved by adding the present value with “1”. In this processing, as in the case of the step S101 of FIG. 6, when 255 is added with 1, the result overflows and thus is set to zero. In order to avoid zero, the addition result is further added with “1” again to set the reception serial number to “1”. After the reception serial number is updated, the processing returns to the step S401.

Next, a specific example of the processing will be described with reference to the processing sequence diagram of FIGS. 10 to 13. In FIGS. 10 to 13, it is also assumed that the computer 201 is operated as an active device 201 and the computer 202 is operated as a standby device 202 as in the case of FIG. 2.

In FIGS. 10 to 13, the state of the serial number managing table 601 stored in the active device 201 is shown in rectangular blocks at the left column, and the state of the serial number managing table 602 stored in the standby device 202 is shown in rectangular blocks at the right column. In FIGS. 10 to 13, the transmission serial number, the reception serial number and the refresh ID stored in the serial number managing tables 601 and 602 are represented by reference numerals of “snd_seg”, “rcv_seq”, “refresh_id”. The type of each of various kinds of packets is written above an arrow, and the value of the refresh ID field and the serial number field of the packet concerned are represented by “refresh_id” and “seq” appended above each arrow.

FIGS. 10 to 13 are diagrams in which attention is paid to a point as to whether the common memory data packet 504 finally reaches the standby device 202 through any one of two routes and a point as to how the serial number managing table 601 of the active device 201 and the serial number managing table 602 of the standby device 202 cooperate with each other. Accordingly, the processing concerning the duplication of a packet when both the two routes are normal is omitted from FIGS. 10 to 13.

FIG. 10 shows an initial state and a result of normal processing subsequent to the initial state. A state AC101 and a state ST101 show the initial states of the serial number managing tables 601 and 602, respectively. In both the states, all the three fields are equal to zero.

When the user application 207 requests the common memory controller 213 to reflect the data 209 to the standby device 202 under the above state, the serial number managing table 601 is set to the state AC102 by the steps S101 to S103 of FIG. 6. Here, the serial number is equal to 1 and the refresh ID is equal to A.

Subsequently, in step S104 of FIG. 6, the refresh request packet 502 is transmitted to the standby device 202. The state of the serial number managing data 602 when the standby device 202 receives the refresh request packet 502 is the same state ST102 as the state ST101. In the standby device 202, the judgment of the step S201 of FIG. 7 is “NO”, and thus the serial number managing table 602 is updated by the steps S202 and S203 so that the state ST102 is changed to the state ST103. Here, the reception serial number is equal to 1 and the refresh ID is equal to A.

Then, in step S204 of FIG. 7, the refresh acknowledge packet 503 is transmitted from the standby device 202 to the active device 201. The state of the serial number managing table 601 when the active device 201 receives the refresh acknowledge packet 503 is the same state AC103 as the state AC102.

Then, the judgment of the step S301 of FIG. 8 is “YES”, and thus the steps S106 to S109 of FIG. 6 are executed. At this time, the state of the serial number managing table 601 is the same state AC104 as the state AC103, so that the value of the serial number field of the common memory data packet 504 transmitted in steps S107 and S109 is equal to 1, and the value of the refresh ID field thereof is equal to A.

The state of the serial number managing table 602 when the common memory data packet 504 is received by the standby device 202 is the same state ST104 as the state ST103. In this case, p=t is judged in step S403 of FIG. 9, so that the ACK packet 505 is transmitted to the active device 201 in step S406, the reception serial number is updated to 2 in step S407 and the serial number managing table 602 is set to the state ST105.

The values of the refresh ID field and the serial number field of the ACK packet 505 transmitted in step S406 are equal to 1. The state of the serial number managing table 601 when the active device 201 receives the ACK packet 505 is the same state AC105 as the state AC104, so that the value of the refresh ID field of the received ACK packet 505 is equal to the refresh ID of the serial number managing table 601, and the value of the serial number field of the received ACK packet 505 is equal to the transmission serial number of the serial number managing table 601.

Accordingly, the data reception thread 405 of the common memory controller 213 can detect that the ACK packet 505 corresponding to the just-before transmitted common memory data packet 504 is normally returned. When the ACK packet 505 is normally returned, the common memory controller 213 notifies this fact to the user application 207. Furthermore, the common memory controller 213 is allowed to accept a request of next data transmission from the user application 207 with the normal reception of the ACK packet 505 as a trigger.

Therefore, when the data transmission for reflecting the data to the common memory 206 is next requested to the common memory controller 213 by the user application, the transmission serial number of the serial number managing table 601 is updated in step S101 of FIG. 6, and the state after the update is the state AC106. In this state AC106, the judgment of the step S102 is “NO”, and the steps S106 to S109 are executed. Accordingly, the value of the serial number field of the common memory data packet 504 transmitted at this time is equal to 2 and the value of the refresh ID field thereof is equal to A.

The state of the serial number managing table 602 when the common memory data packet 504 is received by the standby device 202 is kept to the state ST105. In this case, p=t is judged in step S403 of FIG. 9, and thus the ACK packet 505 is transmitted to the active device 201 in step S406. Furthermore, the reception serial number is updated to 3 in step S407, and the serial managing table 602 is set like the state ST106.

The values of the refresh ID field and the serial number field of the ACK packet 505 transmitted in step S406 are equal to A and 2, respectively. The state of the serial number managing table 601 when the active device 201 receives the ACK packet 505 is the same state AC107 as the state AG106. Therefore, both the value of the refresh ID field of the received ACK packet 505 and the refresh ID of the serial number managing table 601 are equal to A, and also both the value of the serial number field of the received ACK packet 505 and the transmission serial number of the serial number managing table 601 are equal to 2.

Accordingly, the data reception thread 405 of the common memory controller 213 can detect that the ACK packet 505 corresponding to the just-before transmitted common memory data packet 504 is normally returned.

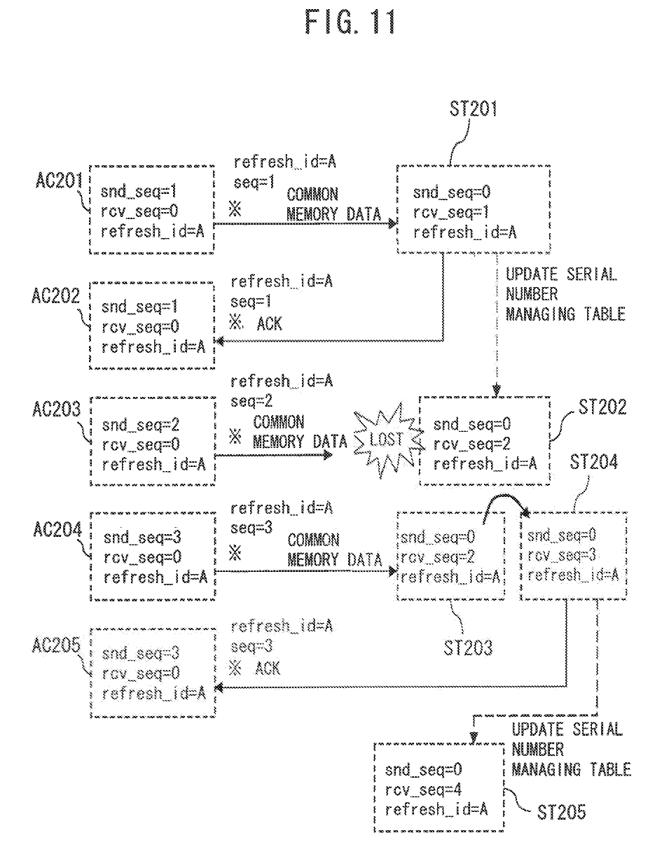

Next, a case where the common memory data packet 504 is extinguished will be described with reference to FIG. 11.

In FIG. 11, a portion comprising a state AC201, a state ST201 and a state AC202, and a portion representing the update from the state ST201 to a state ST202 are portions corresponding to normal transmission. That is, the following steps are normally carried out: the common memory data packet 504 in which the value of the serial number field is equal to 1 is transmitted from the active device 201 and received by the standby device 202 with no problem, the corresponding ACK packet 505 is returned from the standby device 202 to the active device 201 with no problem, and the reception serial number of the serial number managing table 602 is updated from 1 to 2. The state AC201, the state ST201, the state AC202 and the state ST202 are similar to the state AC104, the state ST104, the state AC105 and the state ST105 of FIG. 10, respectively.

When the serial number managing table 601 is the state AC202, the user application 207 requests the common memory controller 213 to reflect the data 209 to the common memory 206. At this time, the transmission serial number of the serial number managing table 601 is updated to 2 in step S101 of FIG. 6, and the state after the update becomes the state AC203. Under this state AC203, the judgment of the step S102 is “NO”, and the steps S106 to S109 are executed. The value of the serial number field of the common memory data packet 504 transmitted at this time is equal to 2, and the value of the refresh ID field thereof is equal to A.

In FIG. 11, it is assumed that both the two common memory data packets 504 transmitted through the first route 215 and the second route 216 are extinguished. Accordingly, the common memory data packet 504 in which the value of the serial number field is equal to 2 and the value of the refresh ID field is equal to A does not reach the standby device 202. Of course, the ACK packet 505 corresponding to this common memory data packet 504 is not returned to the active device 201. Accordingly, the common memory controller 213 of the active device 201 cannot receive the proper ACK packet 505 within a predetermined time from the transmission of the common memory data packet 504, and thus it takes a time-out.

The common memory controller 213 notifies the user application 207 that the transmission of the common memory data packet 504 fails. On the basis of this notification, the user application 207 recognizes the failure of the reflection of the data 209. Thereafter, the user application 207 may request the common memory controller 213 to reflect the data 209 to the common memory 206 again. The re-transmission control of this embodiment is carried out without the responsibility of the common memory controller 213, but with the responsibility of the user application 207. Of course, in another embodiment, the common memory controller 213 may try to re-transmit the data after the time-out.

The time-out enables the common memory controller 213 to accept a request for data transmission from the user application 207.

Therefore, when the user application 207 next requests the common memory controller 213 to reflect the data 209 to the common memory 206, the transmission serial number of the serial number managing table 601 is updated to 3 in step S101 of FIG. 6, and the state after the update becomes a state AC204. Under this state, the judgment of the step S102 is “NO”, and the steps S106 to S109 are executed. Accordingly, the value of the serial field of the common memory data packet 504 transmitted at this time is equal to 3, and the value of the refresh ID field thereof is equal to A.

The state of the serial number managing table 602 when the standby device 202 receives the common memory data packet 504 is the same state ST203 as the state ST202. In this case, p>t is judged in step S403 of FIG. 9. Accordingly, the reception serial number is updated to 3 in step S404, the serial number managing table 602 becomes a state ST204, the content of the common memory data field is reflected to the common memory 206 in step S405, and the ACK packet 505 is transmitted to the active device 201 in step S406. Furthermore, the reception serial number is updated to 4 in step S407, and the serial number managing table 602 becomes a state ST205.

The values of the refresh ID field and the serial number field of the ACK packet 505 transmitted at this time are equal to A and 3, respectively. The state of the serial number managing table 601 when the active device 201 receives the ACK packet 505 is the same state AC205 as the state AC204. Therefore, both the value of the refresh ID field of the received ACK packet 505 and the refresh ID of the serial number managing table 601 are equal to A, and also both the value of the serial number field of the received ACK packet 505 and the transmission serial number of the serial number managing table 601 are equal to 3.

Accordingly, the data reception thread 405 of the common memory controller 213 can detect that the ACK packet 505 corresponding to the just-before transmitted, common memory data packet 504 is normally returned.

In FIG. 11, it is assumed that the two common memory data packets 504 are extinguished on the routes. However, the processing as shown in FIG. 11 is also executed when both the common memory data packets 504 are greatly delayed and reach the standby device 202. This is because the common memory controller 213 cannot discriminate “extinction” and “delay” from each other when it cannot receive a proper ACK packet 505 even after a predetermined time elapses.

Furthermore, the same operation as shown in FIG. 11 is executed even when “NO” is judged in both the steps 5106 and S108 of FIG. 6 and the transmission of the common memory data packet 504 is omitted.

As shown in FIG. 11, the common memory data packet 504 in which the value of the serial number field is equal to 1 is received, whereby the serial number managing table 602 is set to the state ST202. That is, the standby device 202 falls into a state that it expects a common memory data packet 504 having the serial number field value of 2 as a common memory data packet 504 to be next processed.

Furthermore, when “NO” is judged in both the steps S106 and S108 after the transmission serial number is updated from 1 to 2 in step S101 of FIG. 5 and the serial number managing table 601 is set to the state AC203, the common memory data packet 504 in which the value of the serial number field is equal to 2 is not transmitted. In this case, the common memory controller 213 can recognize that the ACK packet 505 is not returned. Accordingly, the common memory controller 213 may immediately accept a request from the user application 207. In this case, by accepting the next request, the transmission serial number is updated from 2 to 3 in step S101, and the serial number managing table 601 is set to the state AC204. If at least one route is normal at this time point, the common memory data packet 504 in which the value of the serial number field is equal to 3 is transmitted as in the case of the processing flow of FIG. 11.

As described above, even when the actually happening phenomenon is extinction, delay or omission of transmission, the serial number managing tables 601 and 602 are properly updated by the same method.

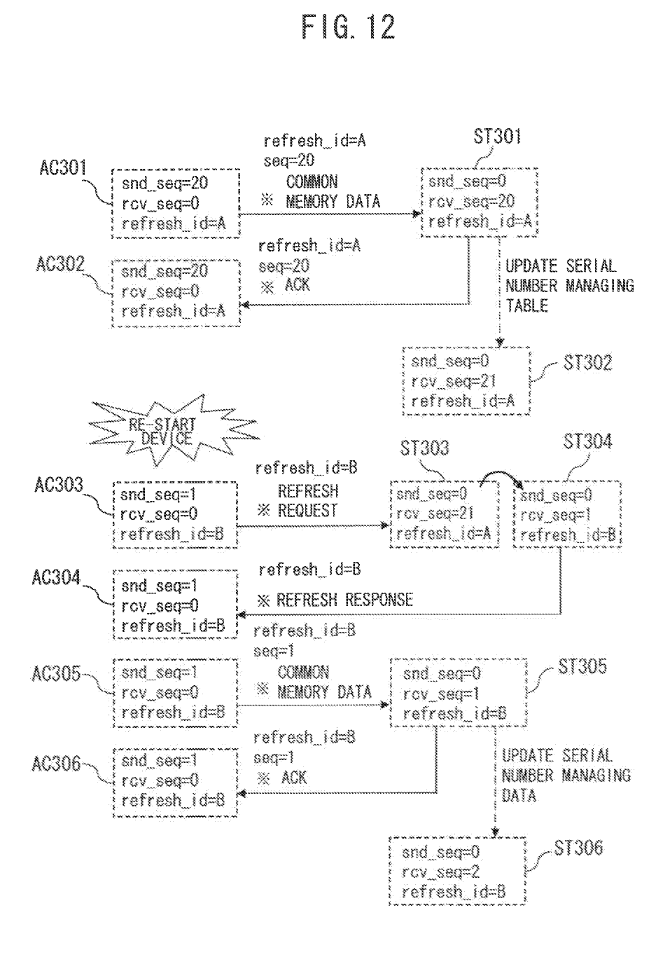

Next, a case where the active device 201 is re-started will be described with reference to FIG. 12. A portion comprising a state AC301, a state ST301, a state AC302 and a state ST302 of FIG. 12 represent that the common memory data packet 504 in which the refresh ID is set to the A state and the value of the serial number field is equal to 20 is normally transmitted and received, and the corresponding ACK packet 505 is normally transmitted and received. This portion is the same as the portion comprising the state AC104, the state ST104, the state AC105 and the state ST105 of FIG. 10 except for specific numerical values.

If the active device 201 is re-started when the serial number managing table 601 is set to the state AC302, all the transmission serial number, the reception serial number and the refresh ID of the serial number managing table 601 are varied to exceptional initial values of zero.

As shown in FIG. 10, in order to properly transmit/receive the common memory data packet 504 and the ACK packet 505, the serial number managing tables 601 and 602 must be set so as to hold the refresh IDs having the same value. However, upon re-start of the active device 201, the value of the refresh ID as “A” is extinguished from the serial number managing table 601. Therefore, the active device 201 is operated according to FIG. 6, the serial number managing tables 601 and 602 are set to hold the refresh IDs having the same value as described below. As a result, the common memory data packets 504 and the ACK packet 505 can be properly transmitted/received.

At this time, when the user application 207 requests the common memory controller 213 to reflect the data 209 to the common memory 206 of the standby device 202 for the first time after the re-start, the serial number managing table 601 is initialized to be set to the state AC303 by the steps S101 to S103 of FIG. 6. Here, the transmission serial number is equal to 1, and the refresh ID is equal to B.

Subsequently, the refresh request packet 502 is transmitted to the standby device 202 in step S104 of FIG. 6. The state of the serial number managing table 602 when the standby device 202 receives the refresh request packet 502 is the same state ST303 as the state ST302, and thus the reception serial number and the refresh ID of the serial number managing table 602 are equal to 21 and A, respectively.

Accordingly, the judgment of the step S201 of FIG. 7 is “NO”, and the serial number managing table 602 is updated in steps S202 and S203, so that the state is changed from the state ST303 to the state ST304. Here, the reception serial number is equal to 1, the refresh ID is equal to B, and the state ST304 is set to the initialized state.

The subsequent processing is the same as shown in FIG. 10 except that the value of the refresh ID is different. That is, a state AC304, a state AC305, a state ST305, a state AC306 and a state ST306 correspond to the state AC103, the state AC1-4, the state ST104, the state AC105 and the state ST105 of FIG. 10.

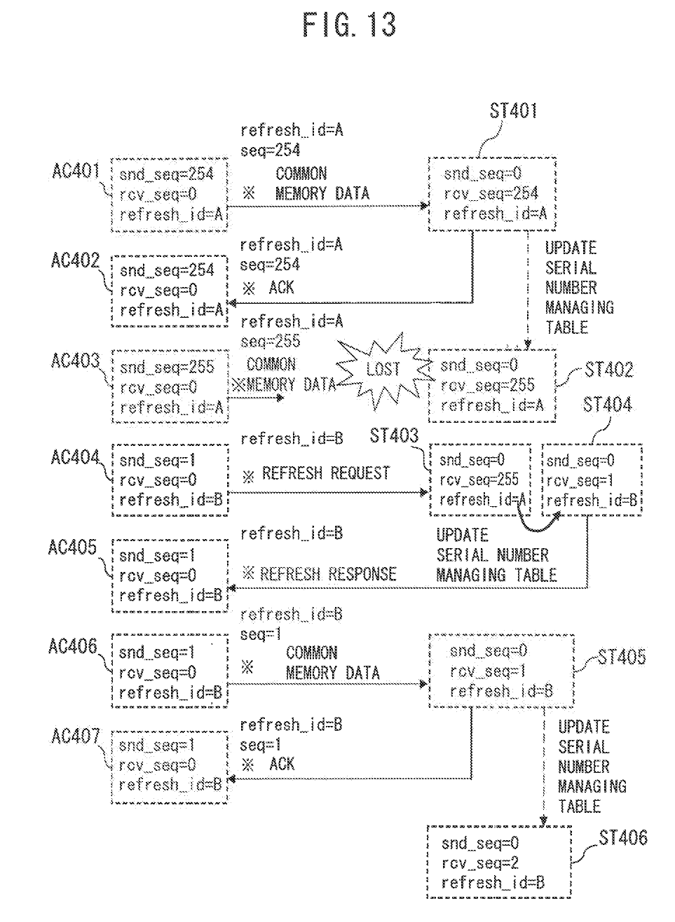

Next, the overflow of the transmission serial number and the reception serial number will be described with reference to FIG. 13. FIG. 13 shows an example of the necessity of the refresh ID. Furthermore, the example of FIG. 13 shows that the common memory controller 214 can correctly grasp the preceding/subsequent relationship between the common memory data packets 504 even when the common memory data packet 504 is extinguished just before overflow occurs in the transmission serial number and the reception serial number by the processing shown in FIGS. 6 to 9.

A portion comprising a state AC401, a state ST401, a state AC402, a state AC403 and a state ST402 of FIG. 13 are the same as the portion comprising the state AC201, the state ST201, the state AC202, the state AC203 and the state ST202 of FIG. 11 except that the specific numerical values are not equal to 1 and 2, but equal 254 and 255. That is, FIG. 13 shows that the common memory data packet 504 in which the value of the serial number field is equal to 254 is normally transmitted and received, the corresponding ACK packet 505 is also normally transmitted and received, and then the common memory data packet 504 in which the value of the serial number field is equal to 255 is extinguished.

The serial number managing table 602 at this time point is the state ST402, and thus the common memory controller 214 of the standby device 202 is set to the state that a common memory data packet 504 in which the value of the refresh ID field is A and the value of the serial number field is equal to 255 is expected and awaited as the common memory data packet 504 to be next processed.

Furthermore, the common memory controller 213 of the active device 201 cannot receive, within a predetermined time, the proper ACK packet 505 corresponding to the common memory data packet 504 in which the value of the serial number field is equal to 255, so that the common memory controller 213 takes a time-out and accepts a next request from the user application 207.

As a result, in step S101 of FIG. 6, the data transmission thread 403 of the common memory controller 213 calculates “0” because “255” is added with “1” and thus overflow occurs, and then further adds the calculated “0” with “1” again to calculate “1”. The data transmission thread 403 of the common memory controller 213 sets the thus-obtained “1” to the transmission serial number of the serial number managing table 601. Furthermore, the judgment of the step S102 is “YES”, and thus a new value “B” is set to the refresh ID field of the serial number managing table 602 in step S103. As a result, the serial number managing table 602 is set like the state AC404.

Then the refresh request packet 502 is transmitted to the standby device 202 in step S104. The state of the serial number managing table 602 when the standby device 202 receives the refresh request packet 502 is the same state ST403 as the state ST402. Accordingly, the judgment of the step S201 of FIG. 7 is “NO”, and thus the serial number managing table 602 is updated and the state is changed from the state ST403 to the state ST404 in the steps S202 and S203. Here, the reception serial number is equal to 1, the refresh ID is equal to B, and the state ST404 is set to the initialized state.

The refresh acknowledge packet 503 is transmitted from the standby device 202 to the active device 201 in step S204 of FIG. 7. The state of the serial number managing table 601 when the active device 201 receives the refresh acknowledge packet 503 is the same state AC405 as the state AC404.

The subsequent processing is the same as shown in FIG. 10 except that the specific value of the refresh ID is different, and it is the processing concerning transmission/reception of the normal common memory data packet 504. That is, even when there is a common memory data packet 504 which is lost just before overflow, a common memory data packet 504 having the value after the overflow in the serial number field is properly processed. Specifically, a portion comprising a state AC406, a state ST405, a state AC407 and a state ST406 is similar to the portion comprising the state AC104, the state ST104, the state AC105 and the state ST105 of FIG. 10.

If there is neither refresh ID nor various kinds of processing concerning it, the common memory controller 214 of the standby device 202 makes a misjudgment when receiving the common memory data packet 504 after the overflow of the transmission serial number. That is, the common memory controller 214 misjudges an actually non-duplicative packet as being duplicated with another packet which was previously received. The refresh ID is a value for identifying the serial numbers having the same value, and it is used to prevent the misjudgment described above. The “serial number” identified by the refresh ID is applied to both “transmission serial number” and “reception serial number”.

If there is neither refresh ID nor various kinds of processing concerning it, the standby device 202 receives the common memory data packet 504 in which the value of the serial number field is equal to 1 under the state that the reception serial number of the serial number managing table 602 is kept to 255. In this case, the step S402 of FIG. 9 is the processing concerning the refresh ID and thus it does not exit. Accordingly, the step S403 is executed just after the step S401 and 1<255 is satisfied, so that the processing returns to the step S401. However, this is erroneous processing.

The refresh ID is used to prevent this misjudgment. The turn represented by the combination of the transmission serial number and the refresh ID contained in the common memory data packet 504 is compared with the turn represented by the combination of the reception serial number and the refresh ID contained in the serial number managing table 602. By the refresh ID and the various kinds of processing concerning it, the common memory controller 214 can accurately judge the turn of the common memory data packet 504 even when overflow is interposed. Furthermore, even when common memory data packets 504 are extinguished before and after overflow, the right judgment can be made.

Next, a block diagram of the computer executing the program of the present invention will be described with reference to FIG. 14.

The program of this invention contains a transmission program and a reception program. The transmission-source computer 101 of FIG. 1 executes the transmission program, and the transmission-destination computer 102 executes the reception program. The computers 201 and 202 of FIG. 2 execute both the transmission program and the reception program. Each of the transmission-source computer 101, the transmission-destination computer 102, the computer 201 and the computer 202 has such a general hardware construction as a computer 700 of FIG. 14.

The computer 700 of FIG. 14 is equipped with CPU 701, ROM (Read Only Memory) 702, RAM 703, a communication interface 704, an input device 705, an output device 706, a storage device 707 and a driving device 708 for a portable storage medium 710, and all these elements are connected to one another through a bus 709.

Furthermore, the computer 700 is connected to a network 711 through the communication interface 704, and it can communicate with the computer 713 as a communication partner through the network 711. That is, in the example of FIG. 1, the network 711 contains the route 107 and the route 108, and in the example of FIG. 2, the network 711 contains the first route 215 and the second route 216. The communication interface 704 may be originally incorporated in the computer 700, or it may be NIC which is afterwards secured to the computer 700. Furthermore, only one block is illustrated as the communication interface 704 in FIG. 14. However, the communication interface 704 physically comprises two NICs, and it may be adapted to each of the two routes.

When the computer 700 is the transmission-source computer 101, the computer 713 of the communication partner is the transmission-destination computer 102, and when the computer 700 is the transmission-destination computer 102, the computer 713 of the communication partner is the transmission-source computer 101. Likewise, when the computer 700 is the computer 201, the computer 713 of the communication partner is the computer 202, and when the computer 700 is the computer 202, the computer 713 of the communication partner is the computer 201.

It is preferable that the computer 700 and the computer 713 of the communication partner are located near each other on the network as when where they are contained in the same segment in LAN (Local Area Network) or the like. This is because when the computer 700 and the computer 713 of the communication partner are located at remote positions on the network like a case where routing based on a router is required, plural routes are frequently overlapped with one another and thus the effect of multiplexing the route is lowered. For example, when all of plural routes are passed through a specific router, a defect in the router affects all the routes. Furthermore, as the computer 700 and the computer 713 of the communication partner are farther away from each other on the network, extinction of packets is generally more liable to occur. As the extinction of packets occurs more frequently, the performance of the overall system to which the present invention is applied becomes more deteriorated.

The common memories 205 and 206 of FIG. 2 are allocated, to a predetermined area of RAM 703, for example. The remaining area, of RAM 703 is used as a control data area for storing the transmission order information 104 or the reception order information 111 of FIG. 1, more specifically, the serial number managing table 601 or 602. The data transfer control table 301 or 302 of FIG. 3 is stored in the control data area.

The input device 705 is a pointing device such as a mouse or the like or a keyboard. The output device 706 is a display device such as a liquid crystal display or the like, for example. The storage device 707 may be a magnetic disc device such as a hard disk or the like, or may be other types of storage devices.

The program according to the present invention is stored in the storage device 707 or ROM 702. A specific example of the program according to this invention is a program of middleware for implementing the common memory controller 213 or 214 of FIG. 2. The program according to the present invention is executed by CPU 701, whereby the processing of FIGS. 6 to 9 is executed.

The program according to this invention may be provided from a program provider 712 through the network 711 such as LAN, the Internet or the like, stored in the storage device 707 and executed by CPU 701. Furthermore, the portable storage medium 710 in which the program according to this invention may be set in the driving device 708, and the stored program may be loaded into RAM 703 and executed by CPU 701. An example of the portable recording medium 710 is an optical disk such as CD (Compact Disc), DVD (Digital Versatile Disk) or the like, a magnetooptical disk, a flexible disk or the like.

The present invention is not limited to the above embodiment, and various modifications may be made. Some of these modifications will be described hereunder.

In the foregoing description, the present invention is applied to the data transmission for data synchronization between two devices. However, the present invention may be applied to data transmission for other purposes. The specific processing to be executed by using the content of a received packet is varied in accordance with the purpose of the data transmission.

The purpose of the data transmission in the embodiment of FIGS. 2 to 13 is directed to the synchronization of data. Accordingly, when the computer 202 of FIG. 2 is applied as a standby device, the common memory controller 214 reflects the content of the common memory data field of the received common memory data packet 504 in step S405 of FIG. 3.

However, the processing using the content of the received packet as described above is inherent to this embodiment. For example, in general, UDP is also used, for multicast or broadcast, and it is used for transmission of streaming data in which importance is attached to real-time performance. When the present invention is applied to the transmission of streaming data on the basis of UDP, the purpose of the data transmission would be reproduction of the streaming data. In this case, the terms of “common memory data packet” and “common memory data field” are improper. However, a packet whose format is similar to the common memory data packet 504 is transmitted, and the step S405 of FIG. 9 is replaced by the processing of reproducing the streaming data contained in the transmitted packet or the processing of requesting reproduction of streaming data to a reproducing application.

The applied target of the present invention affects steps other than the step S405. For example, in another embodiment, when extinction of a packet occurs, the processing concerning a packet corresponding to a turn subsequent to the extinguished packet is not executed. For example, when the packet having the transmission serial number of “3” is extinguished, the packet having the transmission serial number of “4” is discharged even if it is received. In the embodiment as described above, after the execution of the step S404 of FIG. 9, the step S405 is not executed, and the processing goes to step S406.

The operation when the packet is extinguished is also affected by the number of user applications calling the common memory controller 213. FIG. 2 shows only one user application 207, however, plural user applications generally request the reflection of the data 209 to the common memory controller 213.

For example, the common memory controller 213 may process the request from a user application A1 with the transmission serial number of “4” and process the request from a user application A2 with the transmission serial number of “5”. In this case, even when the common memory data packet 504 corresponding to the transmission serial number of “4” is extinguished, the user application A2 is irrelevant, to the extinction of the common memory data packet 504 concerned. Accordingly, if the common memory data packet 504 corresponding to the transmission serial number of “5” is normally received by the standby device 202, it should not be discarded. The content of the common memory data field of the common memory data packet 504 should be reflected to the common memory 206.

On the other hand, in an embodiment in which the common memory controller 213 accepts a request from only one user application A1, an extinguished packet P1 and the next packet P2 necessarily contain data of the same user application A1. Accordingly, in order to keep data compliance, there is a case where it is better to discharge the packet P2 when the common memory controller 214 detects the extinction of the packet P1.

In applications in which partially defective data is permitted, even when a packet is extinguished, the packet is not re-transmitted. In a case where the present invention is used in combination with the user application as described above, when the common memory controller 213 cannot receive the ACK packet 505 within a fixed time after the common memory data packet 504 is transmitted and thus takes a time-out, it is unnecessary for the common memory controller 213 to notify the failure of the transmission to the user application.

In the embodiment of FIG. 9, the ACK packet 505 is returned in step S406 even when the packet is extinguished. However, “ACK-NG packet” as another type of packet indicating extinction may be defined, and the processing of FIG. 9 may be modified so that an ACK-NG packet is returned.

Of course, as is apparent from the sequence, diagram of FIG. 11, the common memory controller 213 at the transmission side can detect, extinction in the processing of FIG. 9. That is, if the serial number fields and the refresh ID fields of two sequential ACK packets 505 do not represent sequential turns, the common memory controller 213 can detect that a packet is extinguished at the discontinuous portion. That is, the ACK packet 505 corresponding to another packet which is received normally after some packet is extinguished also takes a role for notifying the extinction of the packet. However, if the ACK-NG packet is properly defined, by merely reading the value of the TYPE2 field, the common memory controller 213 can detect whether or not packet extinction occurred.

The control packet such as the refresh acknowledge packet 503 or the like may be transmitted through only one route in accordance with the embodiment. Even if the one route is abnormal and thus the refresh acknowledge packet 503 is not normally received, the refresh IDs of the serial number managing tables 601 and 602 can be properly synchronized. In order to establish this synchronization, the common memory controller 213 of the active device 201 may take a time-out and re-try to transmit the refresh request packet 502 again. The refresh request packet 502 and the ACK packet 505 may be likewise transmitted through at least one route and thus it is unnecessary to transmit them through all the routes.

Furthermore, in the example of FIG. 2, it is assumed that the active device and the standby device are alternately switched to each other. Therefore, both the common memory controllers 213 and 214 have both the function of transmitting data and the function of receiving data. However, only the function of transmitting data may be incorporated in one device while the function of receiving data is incorporated in the other device.

The example in which two devices, each of which has both the function of transmitting data and the function of receiving data, are paired, is not limited to the example of FIG. 2. In FIG. 2, the common memory data packet 504 is necessarily transmitted from the active device 201 to the standby device 202. However, in the case of the communication in which data are received/transmitted between two devices X and Y for purposes other than the synchronization of data, both transmission from the device X to the device Y and transmission from the device Y to the device X may occur randomly in an unpredicated order. The present invention can be also applied to such a case. In this case, the timing of updating the refresh ID may be different from that of the embodiment of FIG. 2.

The embodiment of FIG. 2 is based on the assumption that the refresh request packet 502 and the refresh acknowledge packet 503 transmitted/received and the refresh IDs of the serial number managing tables 601 and 602 are updated every time the active device and the standby device are switched to each other. This assumption is not an indispensable assumption, but more preferable from the viewpoint of simplification of the management, etc. as compared with a case where the refresh ID having the same value is continued to be used astride the switching operation.

On the other hand, when both the transmission from the device X to the device Y and the transmission from the device Y to the transmission X occur randomly, if the refresh ID is updated every time a packet is transmitted from the device Y to the device X after transmission from the device X to the device Y, the updating of the refresh ID may be excessively frequent. Accordingly, in this case, the devices X and Y may be designed so that the refresh ID is updated only at the overflow time of the transmission order information and at the re-start time.

In FIG. 2, the embodiment of the present invention is described as the middleware for implementing the common memory controllers 213 and 214. However, the program according to the present invention may be incorporated in OS and it may be an application program. Furthermore, the program according to this invention is not required to be a multi-thread program. Still furthermore, the present invention is not necessarily implemented by software, that is, a program, but it may be implemented by hardware, firmware or any combination thereof.

In the foregoing description, the number of the routes is equal to 2. However, the present invention may be implemented by using three or more routes. For example, when three routes are used, it is necessary to add a third route reception thread to each of the common memory controllers 213 and 214 in addition to the first and second route reception threads 407 to 410 in FIG. 4, and also it is necessary to add the record concerning the third route to the data transfer control tables 301 and 302 of FIG. 3. In the case of the use of the three routes, the processing flow shown in the flowchart is the same as the case where the two routes are used. However, it is frequently practically optimum to use the two routes for the following reason.

(1) Increase of the number of routes accompanies the expansion of hardware such as a cable, etc. and thus increases the cost.

(2) In order to avoid the expansion of hardware, it is possible for plural routes to share the hardware.

However, as the number of the routes sharing the same, hardware is increased, an error is more liable to occur in the hardware. For example, as the number of routes sharing the same cable is increased, a traffic amount on the cable is increased, and thus an error such as collision in the cable is more liable to occur.

(3) It is unusual for trouble to simultaneously occur in two routes which do not share hardware. Therefore, practically sufficient reliability can be obtained by only the two routes.

Furthermore, the packet format shown in FIG. 5 may be modified in accordance with the embodiment. The length of each field and the arrangement order of the fields may be arbitrarily set in accordance with the embodiment. Furthermore, it is needless to say that the types of packets are not hierarchically classified by TYPE1 and TYPE2, but the packet type may be indicated by only one field. The refresh ID field is not required in some embodiments.

That is, when the digit numbers of the transmission serial number and the reception serial number are sufficiently large to the extent that it is practically expected not to re-use the same number, it is unnecessary to use the refresh ID. In that case, no refresh ID field is necessary to each kind of packet, and also no refresh ID field is necessary to the serial number managing tables 601 and 602.

For example, when the system is operated according to a rule under which the device is re-started at a fixed interval, there is a case where the refresh ID field is not required in accordance with the relationship between the digit numbers of the transmission serial number and the reception serial number and the interval of the re-start.

Furthermore, the value of each of the transmission serial number and the reception serial number of the above embodiment is smaller as the turn thereof is more anterior. However, in another embodiment, the value concerned may be larger as the turn is more anterior. In this case, it is necessary to make alterations such as the change of “addition” of the step S102 of FIG. 6 to “subtraction” and the reverse of the judgment of the step S403 of FIG. 9 of “larger than” and “less than”, etc.

Still furthermore, any format other than that of the above embodiment may be adopted for the transmission order information and the reception order information insofar as it may be subjected to the comparison in the before-and-after relationship of the order. For example, in the above example, the reception serial number is the value of the communication serial number itself of the packet which is expected to be next received. However, in another embodiment, the transmission serial number of a finally-received packet is stored as a reception serial number in the serial number managing tables 601 and 602, and the value obtained by adding the stored reception serial number with 1 is compared with the value of the serial number field of the received common memory data packet 504, thereby judging the before-and-after relationship of the order. In this case, this embodiment is different from that of FIG. 6 in that the value used specifically is the transmission serial number of the finally-received packet. However, it is not different in that the reception serial number is a value representing the turn of a packet which is expected to be next received. Likewise, the identification information which is a part of the transmission order information and the reception order information may be information of any format other than the refresh ID as described above.

What is claimed is:

1. A computer-readable storage medium having a reception program recorded therein, the reception program making a transmission-destination computer control the processing of receiving a packet having the same content which is transmitted from a transmission-source computer through plural routes according to a protocol which does not assure arrival of data while transmission order information indicating a transmission order of different packets is contained in the packet concerned, and identifying duplication and extinction of a packet, wherein the processing comprises:
a reception step of receiving the packet transmitted through any of the plural routes;
a transmission order information obtaining step of obtaining the transmission order information from the received packet;
a reception order information obtaining step of obtaining from a storage unit reception order information which is managed on the basis of the transmission order information of packets received previously and represents the order corresponding to a packet which is expected to be next received;
a comparison step of comparing a first order represented by the transmission order information and a second order representing the reception order information;
a duplication judging step of judging that the packet received in the reception step is duplicative with other packets received previously when the first order is prior to the second order;
a normal processing step of the storage unit so that the order represented by the reception order information stored in the storage unit is the next order of the second order when the first order is equal to the second order; and
an extinction judging step of judging that packet extinction occurs when the first order is subsequent to the second order.

2. The computer-readable storage medium according to claim 1, wherein in the normal processing step, the reception program further makes the transmission-destination computer transmit an arrival acknowledge of the packet to the transmission-source computer.

3. The computer-readable storage medium according to claim 1, wherein in the extinction judging step, the reception program further makes the transmission-destination computer update the storage unit on the basis of the transmission order information.

4. The computer-readable storage medium according to claim 1, wherein in the extinction judging unit, the reception program further makes the transmission-destination computer notify extinction of a packet to the transmission-source computer.

5. The computer-readable storage medium according to claim 1, wherein each of the transmission order information and the reception order information contains a number of a finite digital number and identification information for discriminating packets having the numbers having the same values from each other, and the processing further comprises an identification information updating step for updating the storage unit so that the identification information contained in the reception order information is equal to a value indicating a refresh request packet which is transmitted from the transmission-source computer and requests updating of the identification information when the refresh request packet concerned is received, and an arrival acknowledge step for transmitting arrival acknowledge of the refresh request to the transmission-source computer.

6. The computer-readable storage medium according to claim 5, wherein in the comparison step, it is judged that the first turn is prior to the second turn if the identification information contained in the packet received in the reception step is not equal to the identification information contained in the reception order information.

7. A computer-readable storage medium having a transmission program recorded therein, the transmission program making a transmission-source computer control transmission processing of data to a transmission-destination computer according to a protocol which does not assure arrival of the data, wherein the processing comprises;
a transmission order information obtaining step for obtaining transmission order information representing a transmission order of different packets from a storage unit;
at transmission order information updating step for updating the transmission order information stored in the storage unit;
a packet creating step for creating plural packets which contain the same transmission order information and the same transmission target data and respectively correspond to plural routes; and
a transmission step for transmitting the plural packets to the transmission-destination computer through the plural routes according to the protocol.

8. The computer-readable storage medium according to claim 7, wherein the transmission order information contains a number, and the transmission order information updating step adds or subtracts “1” to or from the number contained in the transmission order information, thereby updating the transmission order information.

9. The computer readable storage medium according to claim 7, wherein the transmission order information contains a number of a finite digit number and identification information for discriminating numbers having the same value from each other, and when the number is equal to a predetermined value, the transmission program makes the transmission-source computer execute:
an identification information updating step for updating the identification information before the transmission step;
a refresh request step for transmitting to the transmission-destination computer a refresh request packet for requesting to set the updated identification information to the transmission-destination computer; and
an arrival acknowledge waiting step for waiting for transmission of an arrival acknowledge of the refresh request packet from the transmission-destination computer.

10. The computer-readable storage medium according to according to claim 9, wherein in the identification information updating step, the identification information is updated on the basis of at least one of a date and a time at which the identification information updating step is executed.

11. The computer-readable storage medium according to claim 7, wherein the transmission program makes the transmission-source computer further execute a monitoring step for monitoring the state of each of the plural routes, and in the transmission step, the transmission program makes the transmission-source computer omit transmission through a route whose state is judged as being worse in the monitoring step.

12. The computer-readable storage medium according to claim 11, wherein the monitoring step is a step of receiving monitoring packets transmitted to the transmission-source computer through the plural routes at a predetermined interval by the transmission-destination computer, and judging the respective states of the plural routes on the basis of a reception interval of the monitoring packets.

13. A method of transmitting packets containing transmission order information representing a transmission order of different packets from a first device to a second device, comprising:
creating plural packets that contain same transmission order information and same transmission target data and correspond to the plural routes, and transmitting the plural packets through the plural routes to the second device according to the protocol in the first device; and
discarding a packet received from any one of the plural routes when the transmission order information of the packet concerned is duplicative with the transmission order information of a packet which was previously received.

14. The method according to claim 13, wherein in the second device, information representing the turn corresponding to a packet which is expected to be next received is managed as reception order information on the basis of the transmission order information of the previously received packet, and the received packet is processed if the turn represented by the transmission order information of the received packet is equal to the turn represented by the reception order information.
